(19) United States
(12) Patent Application Publication
(10) Pub. No.: US 2010/0294663 A1
(43) Pub. Date: Nov. 25, 2010

(54) METHODS AND DEVICES FOR ISOTACHOPHORESIS APPLICATIONS

(75) Inventor: Gerhard Weber, Kirchheim (DE)

Correspondence Address: David W. Highet, VP & Chief IP Counsel;Becton, Dickinson and Company, 1 Becton Drive, MC 110, Franklin Lakes, NJ, 07417-1880, US

(73) Assignee: Becton, Dickinson and Company, Franklin Lakes, NJ (US)

(21) Appl. No.: 12/513,165

(22) PCT Filed: Nov. 2, 2007
(86) PCT No.: PCT/EP2007/061840

§ 371 Date: Aug. 6, 2010

Related U.S. Application Data
(60) Provisional application No. 60/863,834, filed on Nov. 1, 2006.

(51) Int. Cl. G01N 27/26; G01N 27/28

(52) U.S. Cl. 204/451; 204/601

(57) ABSTRACT

The invention relates to an operation mode of electrophoresis, which separates and/or fractionates particles of differentiated electrophoretic mobility. More specifically, the invention relates to isotachophoresis (ITP), including free-flow and capillary isotachophoresis, and provides novel electrophoresis methods, as well as kits and devices for carrying out such methods.

### FIELD OF THE INVENTION

The invention relates to an operation mode of electrophoresis, which separates and/or fractionates particles of differentiated electrophoretic mobility. More specifically, the invention relates to isotachophoresis (ITP), including free-flow and capillary isotachophoresis, and provides novel electrophoresis methods, as well as kits and devices for carrying out such methods.

### BACKGROUND OF THE INVENTION

Electrophoresis is a well-established technology for separating particles based on the migration of charged particles under the influence of a direct electric current. Several different operation modes such as isoelectric focusing (IEF), zone electrophoresis (ZE) and isotachophoresis (ITP) have been developed as variants of the electrophoretic separation principle and are generally known to those skilled in the art.

Among electrophoretic technologies, FFE is one of the most promising [Krivanova L. & Bocek P. (1998), “Continuous free-flow electrophoresis”, Electrophoresis 19: 1064-1074]. FFE is a technology wherein the separation of the analytes occurs in liquid medium in the absence of a stationary phase (or solid support material) to minimize sample loss by adsorption. FFE is often referred to as carrier-less deflection electrophoresis or matrix-free deflection electrophoresis.

FFE can be used to separate organic and inorganic molecules, bioparticles, biopolymers and biomolecules on the basis of their electrophoretic mobility. The corresponding principles have already been described in, e.g., Bondy B. et al., “Sodium chloride in separation medium enhances cell compatibility of free-flow electrophoresis”, Electrophoresis 16: 92-97, 1995.

The process of FFE has been improved, e.g., by way of stabilization media and counter-flow media. This is reflected, for example, in U.S. Pat. No. 5,275,706, the disclosure of which is hereby incorporated by reference in its entirety. According to this patent, a counter-flow medium is introduced into the separation space counter to the continuous flow direction of the bulk separation medium and sample that travel between the electrodes. Both media (separation medium and counter flow medium) are eluted from the separation space between the electrodes and discharged through fractionation outlets, typically into a micro titer plate, resulting in a fractionation process having a low void volume. Additionally, a laminar flow of the media in the zone of the fractionation outlets is maintained (i.e., with very low or no turbulence).

A particular FFE technique referred to as interval FFE is disclosed, for example, in U.S. Pat. No. 6,328,868. In this patent, the sample medium and separation media are introduced into an electrophoresis chamber, and the analytes in the sample are separated using an electrophoresis mode such as ZE, IEF or ITP, and are finally expelled from the chamber through fractionation outlets. Embodiments of the '868 patent describe the separation media and sample movement to be unidirectional, traveling from the inlet end towards the outlet end of the chamber, with an effective voltage applied causing electrophoretic migration to occur while the sample and media are not being fluidically driven from the inlet end towards the outlet end. This is in contrast to the technique commonly used in the art wherein the sample and media pass through the apparatus while being separated in an electrical field (continuous FFE).

International patent application WO 02/50524 discloses an electrophoresis method employing an apparatus with a separation chamber through which the separation medium flows and which provides a separation space or chamber defined by a floor, a cover and spacing devices separating these two from each other while maintaining an essentially constant gap between the top and bottom plates of said FFE apparatus. In addition, this FFE apparatus encompasses a pump for supplying the separation medium, which enters the separation chamber via medium feed lines and leaves the chamber via outlets. The FFE apparatus also includes electrodes for applying an electric field within the separation medium, sample injection points for adding the mixture of particles or analytes and fractionation points for removing the particles separated by FFE in the separation medium. The separated particles can be used for analytic purposes or for further preparative processing.

A problem affecting electrophoresis technologies is the instability caused, inter alia, by electrode contamination. Particularly in FFE, the contamination is generally prevented by the use of semi-porous membranes which sequester the electrodes from the separation chamber.

An approach to solve this problem is proposed in U.S. patent applications 2004/050697 and 2004/050698, as well as in International patent application WO 03/060504. Inter alia, these patent applications disclose a so-called focusing buffer used to create a buffer medium in the proximity of the electrodes wherein the focusing buffer medium has a higher conductivity than the separation medium. In the absence of membranes that separate the electrodes from the separation chamber there is the possibility that particles will attach themselves vigorously to the electrode so that there is a significant loss of the separated particles and a concomitant contamination of the electrodes. According to these applications, this effect can be prevented by means of a focusing buffer. However, no guidance is given in U.S. patent applications 2004/050697 and 2004/050698 or in International patent application WO 03/060504 as to the components of the focusing buffer in relation to the separation media, or how to achieve the higher conductivity.

A number of separation media for the separation of analytes such as bioparticles and biopolymers are known in the art. For example, the book “Free-flow Electrophoresis”, published by K. Hannig and K. H. Heidrich, (ISBN 3-921956-88-9) reports a list of separation media suitable for FFE and in particular for free-flow ZE (FF-ZE).

U.S. Pat. No. 5,447,612 (to Bier et al.) discloses another separation medium, which is a pH buffering system for separating analytes by IEF through forming functionally stable pre-cast narrow pH zone gradients in free solution. It employs buffering components in complementary buffer pairs. The buffer's components are selected from simple chemically defined ampholytes and weak acids and weak bases, which are then paired together on the basis of their dissociation characteristics so as to provide a rather flat pH gradient of between 0.4 to 1.25 pH units.

Co-pending US provisional application U.S. Ser. No. 60/885,792 discloses media that can be employed in various electrophoretic operating modes, e.g., zone electrophoresis (ZE), isotachophoresis (ITP) and isoelectric focusing (IEF). Furthermore, the application discloses the use of so-called stabilizing media, which are generally introduced into the electrophoresis chamber in the vicinity of (i.e., near) the cathode and the anode of the electrophoresis device (i.e., between cathode and separation zone, and between the anode and the separation zone), respectively.

Accordingly, stabilizing media are capable of stabilizing the conditions (e.g., pH and electrical conductivity) within the separation space of the electrophoresis device, thereby affording an improved stability of the electrochemical and physical conditions leading to an enhanced accuracy, sensitivity, and reproducibility in the electrophoretic separation/fractionation of analytes in a sample.

Suitable FFE devices are known in the art and are, for example, marketed under the name BD™ Free-flow Electrophoresis System (BD GmbH, Germany). In addition, suitable FFE devices that can be used with the separation and stabilizing media of the present invention have been described in a number of patent applications, including U.S. Pat. No. 5,275,706, U.S. Pat. No. 6,328,868, pending published US applications US 2004/050697, US 2004/050698, US 2004/045826, and US 2004/026251, and International application PCT/EP2007/059010 (claiming priority from provisionally filed applications U.S. Ser. No. 60/863,834 and U.S. Ser. No. 60/883,260), all of which are hereby incorporated by reference.

U.S. patent application 2004/050698 also discloses a free flew electrophoresis apparatus which encompasses at least one separation chamber through which a separation medium can flow. Furthermore, said FFE apparatus encompasses a dosage pump for conveying a separation medium which enters the separation chamber by way of medium feed lines and leaves said chamber by way of outlets, electrodes for applying an electric field in the separation medium and sample injection points for adding a mixture of particles to be separated and fractionation points for removing the particles in the separation medium separated by means of FFE.

As stated above, free-flow electrophoresis may be carried out in different electrophoresis modes. One of these modes, isotachophoresis (“ITP”), is a more recent variant of electrophoresis wherein the separation is carried out in a discontinuous buffer system. Sample material to be separated is inserted between a “leading electrolyte” and a “terminating electrolyte”, the characteristics of buffers being that the leader will comprise ions having a net electrophoretic mobility higher than those of the sample ions, while the terminator must comprise ions having a net electrophoretic mobility lower than those of the sample ions. In such a system, sample components sort themselves from leader to terminator in accordance with their decreasing mobilities in a complex pattern governed by the so-called Kohlrausch regulating function. The process has been described in the art, for instance, in Bier and Allgyer, Electrokinetic Separation Methods 443-69 (Elsevier/North-Holland 1979).

The sample comprising the analyte(s) and, optionally, the spacer compounds (S&S) is introduced in free solution isotachophoresis between the leader and terminator electrolyte zones while being subjected to an electric field and is then separated into pure zones of individual substances in accordance with the differences in their relative electrophoretic mobilities.

Thus, in contrast to free-flow zone electrophoresis (ZE), the separation in ITP is achieved in a non-homogenous separation medium that offers better resolution due to the inherent “focusing effect”. When single particles diffuse out of a separated band of particles during ITP, they enter a medium of varying electrical field strength, resulting in the particles being locally accelerated or decelerated generally towards one of multiple electrodes. The inherent focusing effect causes the slower or faster moving particles to migrate back into the dominant fraction. In some applications, the separation or isolation of particles with known electrophoretic mobility within a migrating field may be improved by the addition of spacers with electrophoretic mobilities slightly greater and slightly less than the particle to be isolated. This is generally termed “stacking” wherein such “spacers” are utilized to physically separate the particle(s) with known and distinct electrophoretic mobility.

An example of the fundamentals of ITP is shown, e.g., in U.S. Pat. No. 3,705,845, “Method in counterflow isotachophoresis”, by Everaerts. FIGS. 1a and 1b of the '845 application are herewith incorporated as FIGS. 1a and 1b and reflect the cross section of an electrophoresis chamber wherein zones of ions with boundaries between the zones have been created. In the '845 patent, Everaerts demonstrates, for example in FIGS. 1a and 1b, an anionic separation of two different anions, C1 and C2, of which C1 is assumed to have a higher mobility than C2. A leading electrolyte zone of anion A and a terminating electrolyte zone of anion B are each created on opposite sides of the sample zone S, which contains C1 and C2. Leading electrolyte zone L with anions A is closer to anode 5 than the sample zone S, while the terminating electrolyte zone T with anions B is closer to cathode 4 than the sample zone S. Everaerts further demonstrates a counter ion R+ in each of the T, L, and S zones.

Zone electrophoresis is an acceptable method in certain cases as a preparative separation mode, but nevertheless may have its drawbacks. For instance, it requires a high field strength in order to effect separation, and it produces a relatively dilute sample compared to the concentration of the sample prior to electrophoretic separation.

The separation of sensitive biomolecules or bioparticles such as organelles or proteins by means of free-flow isotachophoresis would provide several advantages, but attempts to successfully carry out ITP in free solution when separating such sensitive bioparticles have generally been unsuccessful. In order to improve, among other things, the concentration of the analytes of interest (e.g., organelles), it is beneficial in principle to utilize FF ITP as a preparative separation technique since, e.g., the enhanced resolution leads to the ability to elute the analytes of interest within a relatively small volume of attendant buffer.

Up to date, further attempts to carry out free-flow isotachophoresis as successfully as had been achieved in capillary electrophoresis, which is generally a non-preparative separation technique, have failed. There is thus a need in the art to resolve these and other problems associated with isotachophoresis in analytic and preparative free solution electrophoresis techniques.

### SUMMARY OF THE INVENTION

It is an object of the present invention to provide methods and kits enhancing capillary isotachophoretic separation techniques known in the art, and to provide methods, kits and devices that are suitable for free-flow isotachophoretic separation that avoid the drawbacks in the prior art.

The present inventor has found that the methods, kits and devices provided herein can be successfully employed for free-flow isotachophoretic separation of analytes and offer many advantages compared to the available methods in the art. Further advantages and improvements that are provided by the present invention, including improvements for capillary isotachophoretic separation techniques will be illustrated in more detail in the description of the invention herein below.

Accordingly, one aspect of the present invention relates to a novel electrophoresis method comprising:
forming within an electrophoresis chamber a separation zone between a set of electrodes, wherein at least one of the electrodes is a cathode and at least one of the electrodes is an anode, comprising
a terminator electrolyte (T) zone formed by at least one T medium; and
a diluted T zone, formed by at least one diluted T medium; and
a leader electrolyte (L) zone formed by at least one L medium; and
an L stabilizing zone, that is formed by at least one L stabilizing medium; and, optionally, further comprising a spacer (S) zone formed by at least one S medium.

Preferably, the novel electrophoresis method of the present invention is useful for separating at least one analyte of interest from a composition of analytes by isotachophoresis (ITP), and is particularly useful for separations in carrier-less electrophoresis applications such as free-flow isotachophoresis (FF ITP).

Another aspect relates to a capillary isotachophoretic method to separate analytes comprising:
providing an apparatus suitable to carry out a capillary electrophoretic separation comprising two electrodes and a separation zone interposed between said two electrodes, wherein said separation zone is formed by at least:
   a leader electrolyte (L) medium forming an L′ zone; and
   a spacer (S) medium forming an S zone; and
   a modified terminator electrolyte (T′) medium forming a T′ zone.

Yet another aspect of the present invention relates to the use of a novel T medium and a novel T′ medium in an FF ITP separation and a capillary ITP separation, respectively, and to the use of a diluted T medium in an FF ITP separation.

Furthermore, another aspect of the present invention is related to kits providing at least some or all of the media components for carrying out the novel methods according to the present invention. In particular, the kits for carrying out free-flow ITP comprise at least one T medium as further defined herein, but may optionally include also other media or components thereof such as an L medium, an L stabilizing medium, a diluted T medium, and/or at least one S medium.

Finally, novel apparatuses are provided herein which comprise an electrophoresis chamber comprising a set of electrodes, wherein at least one of the electrodes is a cathode and at least one of the electrodes is an anode, and a separation zone interposed between said electrodes, wherein the separation zone is configured to include a terminator electrolyte (T) zone formed by at least one T medium, a diluted T zone formed by at least one diluted T medium, a leader electrolyte (L) zone formed by at least one L medium, and an L stabilizing zone, formed by at least one L stabilizing medium. Optionally, the apparatus may be configured to further include a spacer (S) zone formed by at least one S medium.

The apparatuses are configured to separate at least one analyte of interest from a composition of analytes by free-flow isotachophoresis (FF ITP).

In preferred embodiments, the apparatus contains an, electrophoresis chamber comprising at least 5 inlets through which media are introduced into the chamber wherein two adjacent “a” inlets have an inside bore diameter d of at most a factor of 0.8 compared to the inside bore diameter D of an “A” inlet. Furthermore, at least one “A” inlet is located between said two “a” inlets and each electrode; and the distance between said two adjacent “a” inlets is at most a factor of 0.8 of the distance between a pair of “A” inlets. In addition, the distance between said two adjacent “a” inlets is at most a factor of 0.8 of the distance between an “a” inlet and an “A” inlet.

### BRIEF DESCRIPTION OF THE DRAWINGS

FIGS. 1a and 1b: Isotachophoresis (ITP) embodiments at the starting conditions (FIG. 1a), and at a time after commencement of the electrophoretic separation (FIG. 1b) as disclosed in U.S. Pat. No. 3,705,845: ITP separation of anions in a capillary (free-solution capillary) electrophoresis. In the '845 patent, the leading electrolyte (L), terminating electrolyte (T), sample zone (S), and counter-ion R are generally defined.

FIGS. 2a and 2b: Schematic representation of ITP starting conditions (FIG. 2a) and during separation (FIG. 2b) as practiced in the prior art. Sample and spacers (S&S) were mixed and the mixture was introduced between the leader and terminator electrolyte zone.

FIG. 3: A schematic FF ITP separation carried out in an exemplary FFE separation chamber.

FIGS. 4a to 4c: Schematic representation of conditions at sections A, B, and C as indicated in FIG. 3

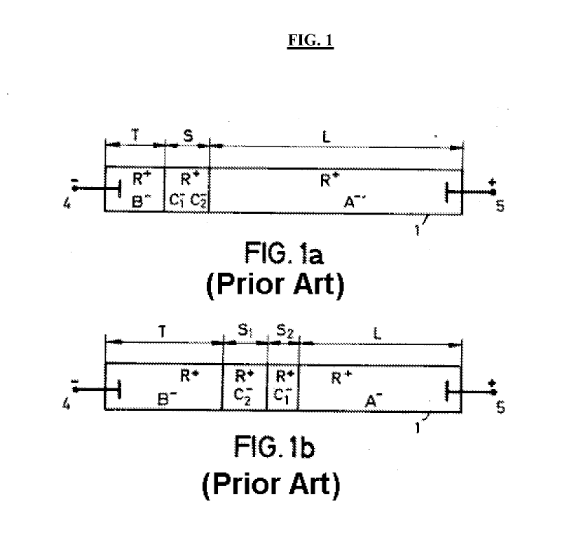

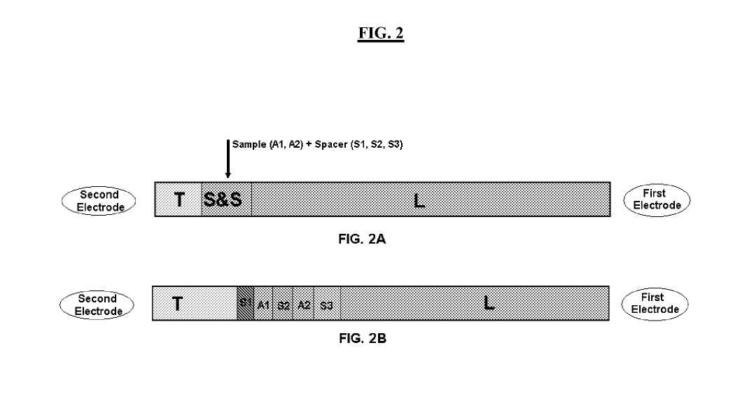

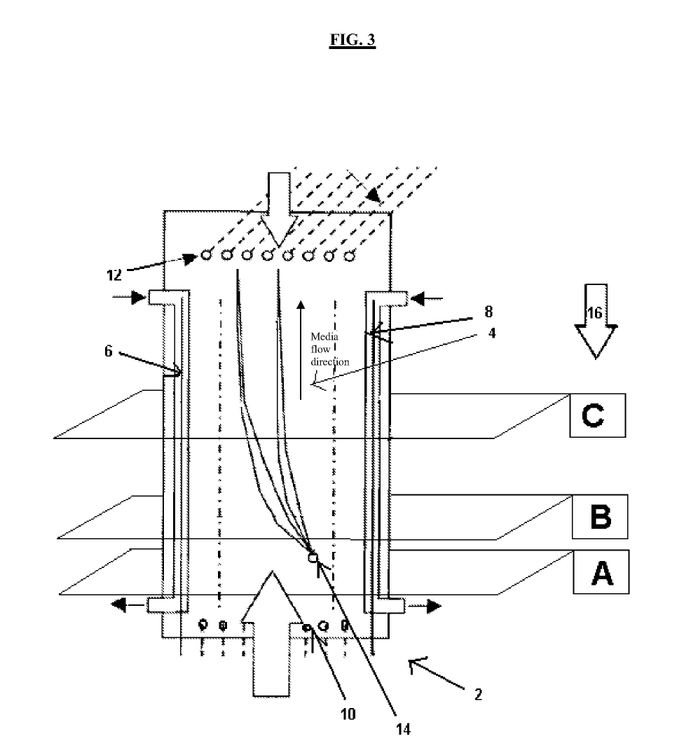

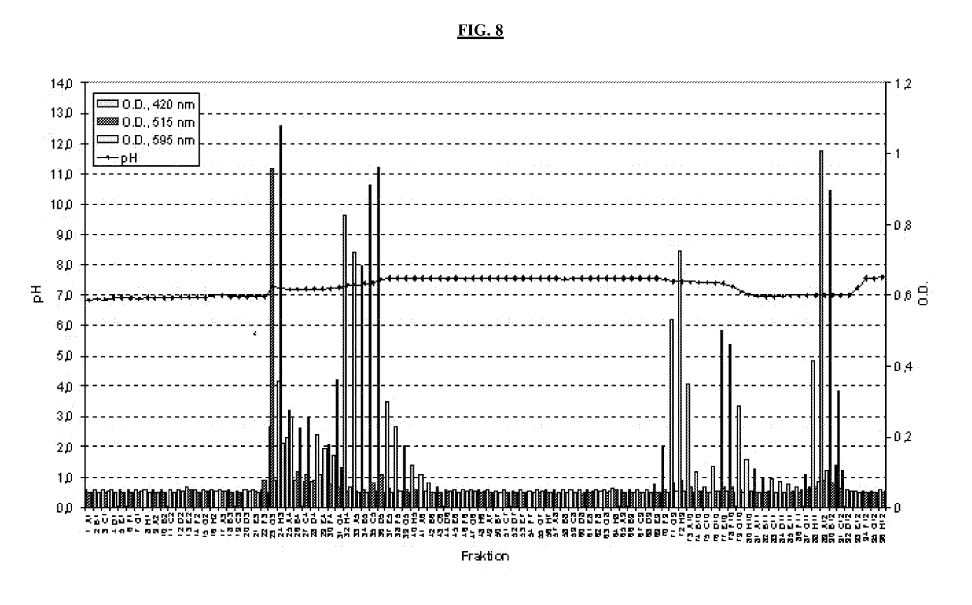

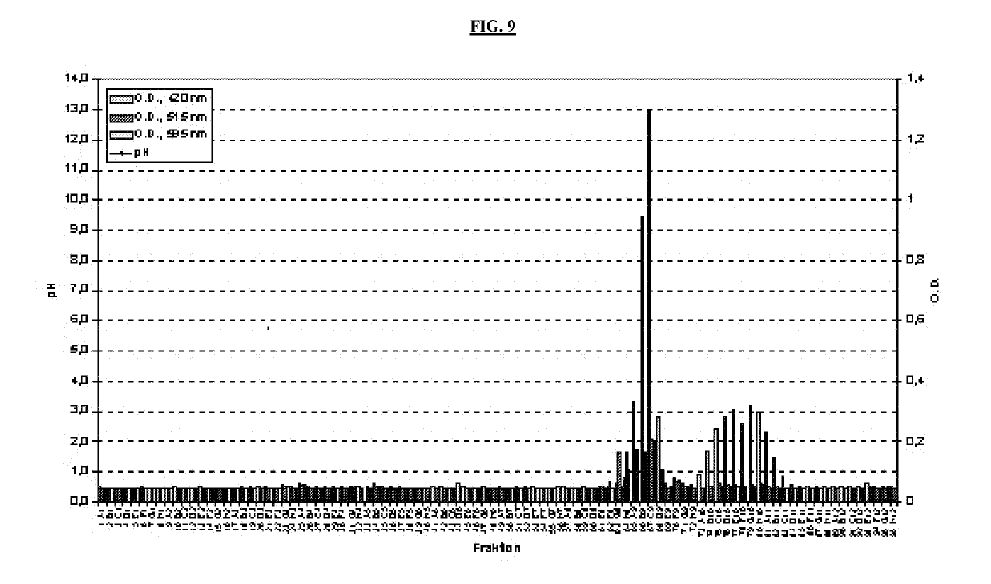

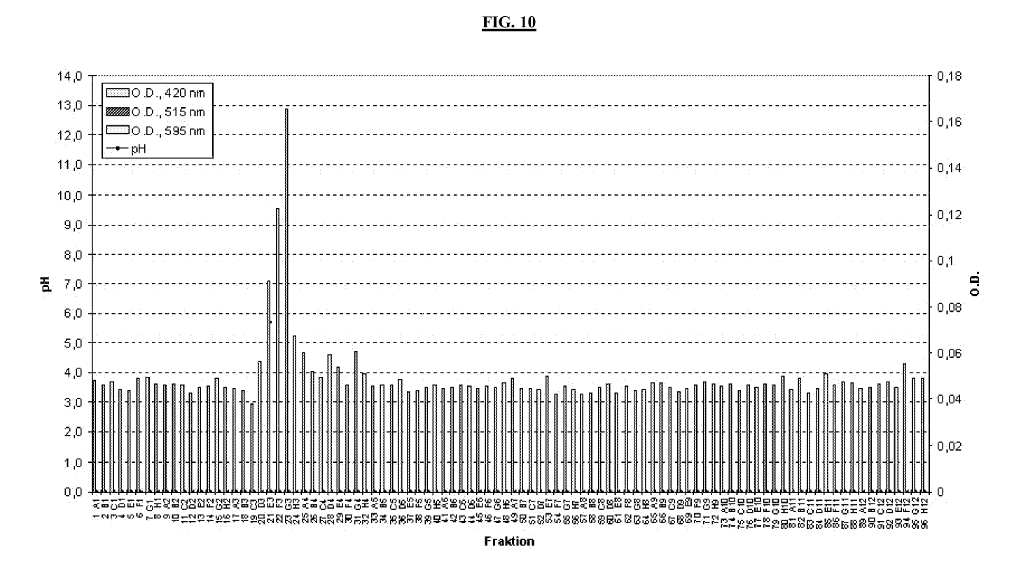

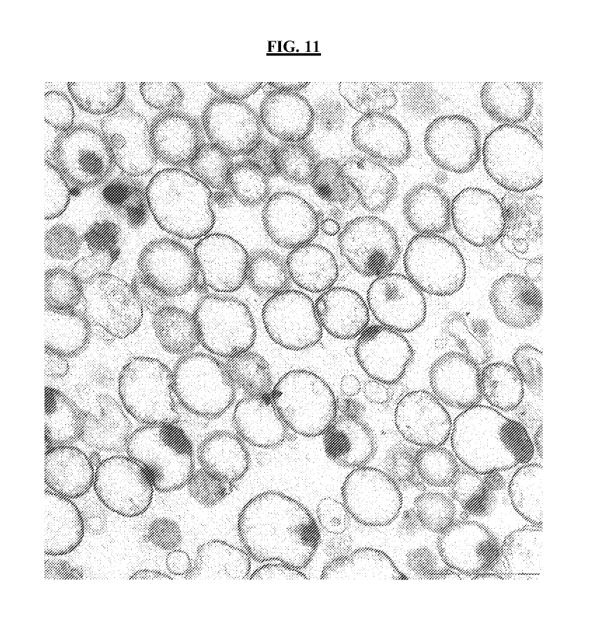

Section A (FIG. 4a): Initial starting conditions showing the introduced electrolytes and spacer electrolytes. Between a first (right side) electrode and a second (left side) electrode, the separation space contains a L stabilizing zone (conc. L.), a leader electrolyte (L) zone, a spacer electrolyte (S) zone (comprising spacer ions S1, S2, and S3), a concentrated terminator electrolyte T zone (T conc.) and a diluted T zone (T conc./X) that has been diluted by a factor X as described herein.

Section B (FIG. 4b): Conditions showing the separation space once the sample has been added into the flow of the electrolytes as depicted in FIG. 4a. At this point the sample introduction port (14) is positioned between the first and second electrodes and the sample including sample ions S1 and S2 is introduced into the separation media. In some embodiments at section B, an electric field may be already have been established while in other embodiments, the electric field will be established shortly thereafter while the sample is located between sections B and C.

Section C (FIG. 4c): Condition representing the movement and stacking effect of isotachophoresis generated from an electric field applied between the first and second electrode. The condition is formed by the proper selection and positioning of L, sample ions (A1 and A2), spacer ions (S1, S2, and S3), T conc., T conc./X and T_{s dil} (strongly diluted) as defined above. In certain embodiments of the invention, a terminator electrolyte T_{s dil} zone is formed wherein the concentration of the terminator T in the T_{s dil} zone is even less than the concentration of T conc./X in the T conc/X zone. The concentration of terminator electrolyte zone T is determined by the concentration of leader and sample electrolyte zones through the Kohlrausch equation.

FIG. 5: A schematic view of an apparatus as used in the art to carry out free-flow isoelectric focusing (FF IEF), free-flow zone electrophoresis (FF ZE) or free-flow isotachophoresis (FF ITP).

FIG. 6: A separating device as used in the art to separate media inlets within an FFE apparatus.

FIG. 7: Schematic view of a novel separating device suitable for carrying out FF ITP methods according to the present invention.

FIG. 8: An FFE elution profile represented by the absorbance of the FFE fractions at λ=420 nm, 515 nm, and 595 nm which visualize the distribution of the respective pI-markers in an optimized FF ITP separation according to the present invention carried out in continuous mode. The pI marker were introduced as a sample.

FIG. 9: An FFE elution profile represented by the absorbance of the FFE fractions at λ=420 nm, 515 nm, and 595 nm which visualize the distribution of the respective pI-markers in an FF ITP separation carried out according to a typical ITP protocol (using the same pI markers, leader, spacer, and terminator ions as used in the optimized FF ITP methods according to the present invention).

FIG. 10: An FF ITP elution profile of a sample comprising peroxisomes. Fractions comprising peroxisomes were identified by measuring the absorbance of the FF ITP fractions at λ=420 nm.

FIG. 11: Electron microscopic picture (x4646) of peroxisomes after FF ITP separation according to Example 2.

### DETAILED DESCRIPTION OF THE INVENTION

The present invention provides advantageous methods that are useful for the separation or fractionation of particles, e.g., by isotachophoresis (ITP), including free-flow isotachophoresis (FF ITP) and capillary isotachophoresis. The improved electrophoresis methods enable the successful separation of particles that could not be separated with the previous ITP methods known in the art. While the ITP separation methods of the present invention can generally be carried out with any electrophoresis application, the novel methods are believed to be particularly suitable for capillary electrophoresis and free-flow electrophoresis.

Accordingly, one aspect of the present invention relates to a novel electrophoresis method, comprising:
forming within an electrophoresis chamber a separation zone between a set of electrodes, wherein at least one of the electrodes is a cathode and at least one of the electrodes is an anode, comprising
   a terminator electrolyte (T) zone formed by at least one T medium; and
   a diluted T zone, formed by at least one diluted T medium; and
   a leader electrolyte (L) zone formed by at least one L medium; and
   an L stabilizing zone formed by at least one L stabilizing medium;
   and, optionally, further comprising a spacer (S) zone formed by at least one S medium.

Optionally, the method may further comprise the introduction of a sample or at least one analyte of interest into the electrophoresis chamber.

In preferred embodiments, the method is for separating at least one analyte of interest from a composition of analytes by isotachophoresis (ITP).

In accordance with the present invention, a sample comprising analyte(s) to be separated may be introduced into an electrophoresis chamber together with a spacer medium prior to the establishment of equilibrium conditions between the different media. In preferred embodiments, however, for example if the novel method is performed as FF ITP separation, a sample may be introduced into a separation chamber downstream of the introduction point of the various media, for example after equilibrium conditions of the different media are already established. In other words, the sample is not introduced together with the spacers or further separation media, but is rather introduced after equilibrium conditions of the different media have already been established. In certain embodiments the sample is introduced into the actual separation region (i.e., where an electric field is present between the electrodes).

In this regard, it will be understood that the sample may generally be introduced at a position between the media inlets and the actual separation region (i.e., where an electric field is present between the electrodes), or can be placed directly within said field.

Additionally, preferably for FF ITP, it is noted that a sample can be introduced at different positions perpendicular to the bulk flow direction depending on the alignment of the different zones within a separation zone according to the present invention. Thus, a sample may be introduced into the S zone, or may alternatively be introduced between the S zone and the diluted T electrolyte zone. The sample may also be introduced into the diluted T zone, between the S zone and the L zone, or into the L zone.

Preferably, however, the sample is introduced at a position between the media inlets and the actual separation zone between two electrodes of an apparatus suitable to carry out an FF ITP separation.

The ITP methods according to the present invention are suitable for subsequently analyzing at least one analyte of interest either within the separation zone, or after eluting the analytes from the separation zone and, optionally, after discharging at least one fraction from a separation chamber, and optionally recovering at least one part of the analyte of interest in one or a plurality of fractions.

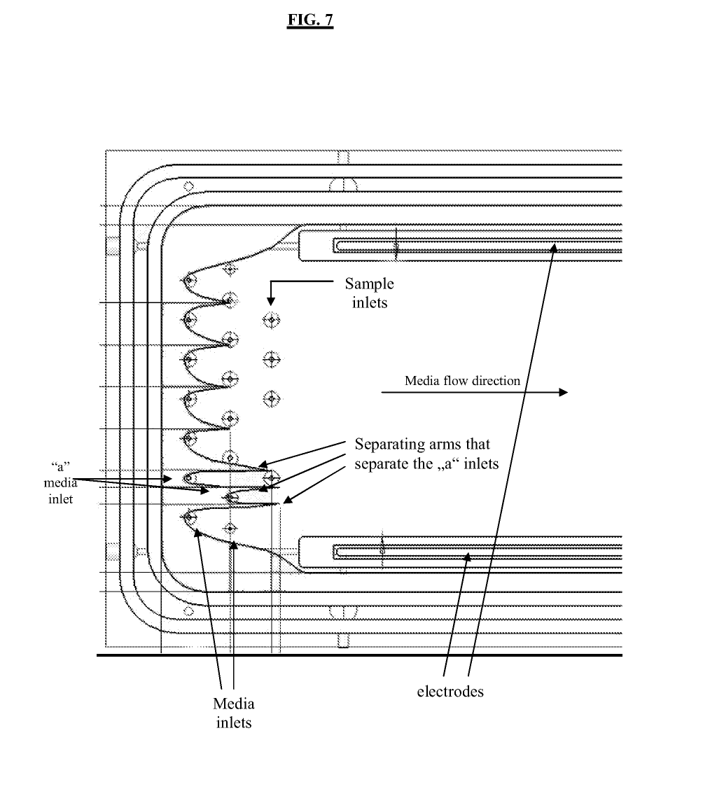

General embodiments of the invention for free flow isotachophoresis (FF ITP) are depicted in FIGS. 3 and 4.

FIG. 3 is a schematic representation of an FF ITP separation carried out in an FFE separation chamber. Said separation chamber (2) comprises a separation zone (4) flanked by a first electrode (6) and a second electrode (8). Separation media inlet ports (10) are located at a first end of the chamber (2) and outlet ports (12) are located, for instance, at the opposite end. A sample inlet (14) is located to be in fluid communication with the separation zone between the two electrodes, and additionally located longitudinally (parallel to the electrodes) between the media inlet ports (10) and outlet ports (12), preferably closer to the media inlet ports (10) than the outlet ports (12). It will be understood that a sample inlet (14) may be located such that said sample inlet may introduce a sample into the chamber (2) in front of or within an electrical field formed between the electrodes (6 and 8). Cross-sections through the planes A, B and C are described schematically in FIGS. 4a to 4c.

Cross-sections through planes A, B and C as indicated in FIG. 3 are depicted in FIGS. 4a, 4b and 4c. Essentially, FIG. 4a shows the initial starting condition of the separation medium being introduced into the chamber prior to introducing the sample. FIG. 4b shows the separation situation immediately downstream from the sample introduction port 14 (see FIG. 3) into the spacer (S) zone. The sample introduction port is preferably independently controlled by a separate pump to introduce the sample into the separation media. FIG. 4c shows the situation after application of an electric field demonstrating the development of the FF ITP electrophoretic conditions when compared to the conditions depicted in FIG. 4b. As shown in FIG. 4c, sample “stacking” has already taken place.

For anionic separations using embodiments of the present invention, electrode (8) of FIG. 3 is the anode and electrode (6) is the cathode, with respective voltage potentials. For cationic separation using embodiments of the present invention, electrode (8) of FIG. 3 should accordingly be the cathode, and electrode (6) should be the anode. Therefore, the various embodiments of the present invention can be used to carry out both anionic and cationic separations, depending on the charge of the analyte of interest as will be described in further detail herein below.

The use of a novel buffered and ionized terminator electrolyte (T) medium, a diluted buffered and ionized T medium, and a buffered leader electrolyte (L) medium in ITP methods according to the present invention offers several advantages compared to ITP methods known in the art.

For example, better resolution of the different zones during an FF ITP separation and therefore a better separation can now be achieved utilizing the teachings of the present invention. Furthermore, the use of at least one T medium, at least one diluted T medium and at least one L medium according to the present invention provides an essentially constant pH over the whole width of the separation zone between the electrodes of an apparatus suitable to carry out an ITP separation. Also in accordance with the present invention, the use of a buffered and ionized T medium leads to an advantageous higher conductivity of the terminator zone when compared to the methods known in the art, and the introduction of a diluted T medium notably reduces the discontinuity of the electrical conductivity at the interface of a T zone and a spacer or sample zone. The use of these advantageous media and the adjustment of the concentrations of a leader L, a terminator T and buffer compounds within the different media allows the skilled person to achieve an essentially constant conductivity and/or pH throughout a diluted T zone, an S zone and an L zone over the whole separation zone and therefore an enhanced separation of analytes as demonstrated in the instant application.

The ITP methods of the present invention allow the use of leader and terminator ions having an electrophoretic mobility ratio (V_{L}:V_{T}) of <17. Another advantage of the present invention is that even analytes having a difference in their electrophoretic mobility of less than 5% and even less than 3% can be separated successfully with the ITP methods described herein.

In the context of the present application, the terms “to separate” and “separation” are intended to mean any spatial partitioning of a mixture of two or more analytes based on their different behaviors in an electrical field. Separation therefore includes, but is not limited to, fractionation, to a specific and selective enrichment or depletion, and concentration and/or isolation of certain fractions or analytes contained in the sample. However, in the context of the present invention, it will be appreciated that fractionation is generally understood to mean a partitioning or enrichment of certain analytes within a sample from the remainder of the analytes, regardless of whether other analytes are further separated during the electrophoresis step. It is readily apparent that there is no clear distinction between the term fractionation and separation, although the latter means a finer or more detailed spatial partitioning of the various analytes in a sample. Thus, when the application refers to the terms “to separate” or “separation”, they are intended to include at least one of the foregoing meanings including separation, fractionation, isolation, enrichment or depletion. In preferred embodiments, an analyte of interest is, however, isolated from other particles or species in the sample.

The term “to elute” in the context of the present invention relates to the removal or disposal of analytes from the separation zone between the electrodes of an electrophoresis chamber, whereas the term “to discharge” refers to the removal of analytes from the electrophoresis chamber, wherein the isotachophoretic separation was carried out.

The separation may principally be carried out in a preparative manner so that certain fractions are subsequently collected or recovered, or may merely be carried out analytically where the analyte of interest or its presence in a certain fraction is merely detected by suitable means, but not collected, e.g., for further use.

The term “a” as used in the present application is to be understood as “one”, “at least one” or “one or more”.

As used herein, the term “sample” refers to any composition whereof at least a part is subjected to an electrophoretic separation according to the present invention. Typically, a sample comprises, or is suspected of comprising, at least one analyte of interest.

The terms “analyte of interest”, “molecule of interest” and “analyte to be separated” are used interchangeably herein to indicate a molecule or particle that is to be separated, isolated, detected, quantified, or otherwise examined, studied or analyzed. It will be appreciated that an “analyte of interest” not always needs to be identified prior to separation, isolation, detection, quantitation, examination, analysis, etc. Non-limiting examples of analytes of interest that can be separated in accordance with the present invention are bioparticles, biopolymers and biomolecules such as cells, viruses, virus particles, organelles, liposomes, hormones, cellulose derivatives, antibodies, antibody complexes, protein aggregates, protein complexes, proteins, lipophilic proteins, acidic proteins, peptides, DNA-protein complexes, DNA, membranes, membrane fragments, lipids, nanoparticles, saccharides and derivatives thereof, polysaccharides and derivatives thereof, mixtures thereof, and the like.

In some preferred embodiments, the analyte of interest is a cell, an organelle, an acidic protein, a lipophilic protein, or a nanoparticle.

Furthermore, inorganic or organic molecules which can be separated in accordance with certain embodiments of the invention may be charged polymers or complexes, polyacids, pharmaceutical drugs, prodrugs, a metabolite of a drug, toxins, carcinogens, poisons, allergens, infectious agents and the like.

The term “organelle” as used herein means a specialized subunit in vivo located within a cell. In certain embodiments, such organelles may have a specific function and/or may be separately enclosed within their own lipid membrane. The term “organelle” is to be understood as synonymous with “cell compartment”. Non-limiting examples of organelles in accordance with the present invention are mitochondria, chloroplasts, endoplasmatic reticulum, Golgi apparatus, nuclei, vacuoles, ribosomes, vesicles, peroxisomes, nucleoli, parenthesomes, mitosomes, melanosomes, glycosomes, glyoxysomes, and the like.

The term “lipophilic proteins” as used herein refers to proteins having at least one lipophilic part. Membrane associated proteins, which are in vivo capable of interacting with membranes by means of van der Waals forces are typical, but non-limiting examples for a lipophilic protein. Optionally, lipophilic proteins may encompass proteins containing polar or ionic groups which, e.g., interact with the polar headgroups of a membrane. Non-limiting examples are dehydrins comprising K-segments, or receptors. Receptor molecules are recognized in the art and generally have an extracellular, an intracellular and/or a transmembrane domain.

The term “nanoparticle” as used herein also comprises the terms “nanopowder”, “nanocluster” or “nanocrystal”. The term “nanoparticle” refers to a microscopic particle with at least one dimension less than about 120 nm. The skilled person will understand that nanoparticles are effectively a bridge between bulk materials and atomic or molecular structures. Said nanoparticles exhibit a number of special properties relative to bulk material. For example, the bending of bulk copper (wire, ribbon, etc.) occurs with movement of copper atoms/clusters at about the 50 nm scale. Copper nanoparticles smaller than 50 nm are considered super hard materials that do not exhibit the same malleability and ductility as bulk copper. At the small end of the size range, nanoparticles are often referred to as clusters. Nanospheres, nanorods, and nanocups are just a few of the shapes that have been produced in the art. Metal, dielectric, and semiconductor nanoparticles can be separated according to the present invention, as well as hybrid structures (e.g., core-shell nanoparticles), semi-solid and soft nanoparticles. A prototype nanoparticle of semi-solid nature is, e.g., the liposome. Such nanoparticles may be used in biomedical applications as drug carriers, or as imaging agents. For example, various types of liposome nanoparticles are currently used clinically as delivery systems for anticancer drugs and vaccines and may be separated in accordance with the methods of the instant invention.

The term “terminator electrolyte” or “terminator” as used herein refers to a molecule and/or to a charged species derived therefrom. Notably, both the terminator molecule or the charged species derived therefrom have an electrophoretic mobility (EM) that is by definition lower than the EM of an analyte of interest.

In preferred embodiments of the present invention, at least a portion of said terminator T is charged, i.e. a charged species (ion) may derive from said terminator, for example by dissociation into a charged species and its counter ion, by protonation or by deprotonation. Depending on the separation problem and whether the analyte is positively or negatively charged, it must be distinguished between cationic ITP wherein the species travel towards the cathode and anionic ITP where the species in the solution travel to the anode. Therefore, in cationic ITP at least part of the terminator T is a cationic (positively charged) species, and in the latter case of anionic ITP, at least part of the terminator T is an anionic (negatively charged) species.

In certain embodiments of the present invention, the terminator T may be an acid, a base, a salt, or any compound, which is at least partially charged under the conditions suitable to carry out an ITP separation according to the present invention. In more preferred embodiments, the terminator T is a buffer compound. It should be understood that the terminator T has generally the lowest electrophoretic mobility (EM) of all (partially) charged species within a system suitable to perform an ITP compared to the leader L, spacer compounds, or analytes. Notably, the EM of H⁺ and OH⁻ are not considered when defining the EM of one of the afore-mentioned compounds as lowest or highest EM. The electrophoretic mobility EM (or μₑ) is defined as the coefficient between particle speed (V) and electric field strength (E):

$${μ}_{e} = \frac{v}{E}$$

In the context of free-flow isotachophoresis, the term “T medium” as used herein relates to a medium comprising a terminator T and at least one strong acid or strong base, respectively. It must be understood that terminator compounds as employed in classical (e.g., capillary) ITP are not suitable for free-flow ITP because of their low electrical conductivity and low buffering capacity.

Therefore, a T medium suitable to carry out an anionic ITP separation in accordance with the present invention comprises the terminator T, with the proviso that the EM of the terminator T is lower than the EM of the analyte of interest, and additionally comprises a strong base (e.g., NaOH). Optionally, the medium may further comprise additives. The terminator T is usually selected from a buffer acid, wherein a pKa of said buffer acid is preferably higher than a pKa of the buffer base in the anodic leader medium. The concentration of the strong base added to the T medium is preferably lower than the concentration of the buffer acid in the same medium, but high enough to ensure a high degree of ionization in order to achieve the desired high conductivity. Preferably, the strong base is an alkali metal hydroxide or an alkaline earth metal hydroxide. In more preferred embodiments, the strong base is sodium hydroxide (NaOH) or potassium hydroxide (KOH).

Those of skill in the art will understand that the terminator T is selected according to the preferred separation conditions. In preferred embodiments, the pH of a T medium is about equal to a pKa of T, i.e. the terminator T is preferably chosen so that its pKa value matches the pH of the intended T medium in order to achieve a suitable buffering capacity of the T medium. Accordingly, it is preferred that the concentration of said strong base is about a factor of 1.0 to 4.0, preferably about a factor of 1.2 to 3.0, and more preferably about a factor of 1.8 to 2.2 less than the concentration of T within a T medium. In even more preferred embodiments, the concentration of said strong base is about a factor of 2 less than the concentration of T within a T medium to achieve a maximum buffer capacity of said terminator T.

T compounds suitable to perform ITP such as HEPES and morpholinoethanol are generally known to the skilled artisan. Together with teachings provide herein, the person skilled in the art will be able to select a suitable terminator T for carrying out an ITP separation according to the present invention.

A T medium suitable to carry out a cationic ITP according to the present invention will comprise the terminator T and a strong acid such as formic acid, hydrochloride or sulfuric acid. Optionally, the T medium may comprise further additives. In preferred embodiments, the pH of a T medium is about equal to a pKa of T, i.e. the terminator T is preferably chosen so that its pKa matches the pH of the intended T medium to achieve a suitable buffering capacity of the T medium. The concentration of the strong acid added to the anodic T medium is preferably lower than the concentration of the buffer base in the same medium, but high enough to ensure a high degree of ionization in order to achieve the desired high conductivity. To achieve a good buffering capacity of the T medium, it is most preferred that the concentration of said strong acid is about a factor of 1.0 to 4.0, preferably about a factor of 1.2 to 3.0, and more preferably about a factor of 1.8 to 2.2 less than the concentration of T within a T medium. In even more preferred embodiments, the concentration of said strong acid is about a factor of 2 less than the concentration of T within a T medium in order to achieve a maximum buffer capacity of said terminator T.

Again, the skilled person will understand how to select a suitable terminator T for carrying out an ITP separation according to the present invention. Because of the advantageous features of a T medium and a diluted T medium according to the present invention, respectively, they are especially useful for FF ITP separations.

The term “diluted T medium” as used herein may relate to a “T medium” wherein the entire medium has been diluted, or may relate to a medium wherein the terminator T and the strong base or strong acid, respectively, are diluted compared to the concentration of the buffer system of a “T medium”, while further additives such as antioxidation agents, viscosity enhancers and the like may be present in the diluted T medium in the same concentrations as in the corresponding T medium, or may optionally be diluted in another ratio.

In preferred embodiments, the concentration of T in a diluted T medium is about a factor of 2 to a factor of 20, preferably about a factor of 3 to a factor of 10, and more preferably about a factor of 5 to a factor of 8 less than the concentration of T in an adjacent T medium.

The use of a diluted T medium offers the advantage of providing a boundary adjacent to the effective separation zone as defined herein that avoids a sudden increase in the electrical conductivity of the adjacent media. Therefore, disturbances between the different zones such as, e.g., heating effects caused by the different media or different electrical field strengths as observed in methods of the prior art can be minimized by using the diluted T medium as described herein.

The term “spacer S medium” relates to a compound or composition of compounds wherein the compounds have an EM approximately corresponding to the EM of the analyte(s) of interest. Such spacer compounds and their electrophoretic mobilities are generally known in the art and the skilled person will know how to select suitable spacer compounds dependent on the separation problem. Some exemplary compounds that may be used as spacers are ACES, acetic acid, aspartic acid, alpha-hydroxy-butyric acid, EPPS, gluconic acid, glucuronic acid, glutamic acid, HEPES, lactic acid, MES, MOPSO, MOPS, picolinic acid, pivalic acid, POPSO, propionic acid, pyridinesulfonic acid, and the like. In general, any chemical that is compatible with the analyte to be separated can be used, if the EM-value will typically be within the range of about 5 and 40×10⁻⁹×m²×V⁻¹×sec⁻¹, although it will be appreciated that the EM value of a spacer will always depend on the actual EM of the analyte(s) of interest.

It is generally preferred to adapt certain properties of the S medium such as the pH and/or the electrical conductivity to the requirements of the separation problem. Thus, in some preferred embodiments, a (strong) acid or a (strong) base may be added to adapt the S medium to the intended separation conditions. Optionally, the S medium may comprise further additives.

The term “leader electrolyte” or “leader” as used herein refers to a charged species (ion) and the compound from which said charged species is derived, e.g., by dissociation of said compound into a charged species and its counter ion, or by protonation/deprotonation. The leader L by definition has the highest EM of all charged species within a system suitable to perform an ITP, i.e., the EM will be higher than that of the terminator species, any spacer compounds, and analytes of interest. Notably, as previously stated, the EM of H⁺ and OH⁻ are not considered when defining the EM of one of the afore-mentioned compounds as the lowest or highest EM in the separation chamber.

As in the case of the terminator T, it must be distinguished between cationic ITP wherein the analyte of interest as well as the leader, spacer and terminator ions travel towards the cathode, and anionic ITP where the species in the solution travel to the anode. Therefore, in cationic ITP the leader L is a cation, and in anionic ITP the leader L is an anion. Preferably, the leader L is derived from a strong base or a strong acid, although other sources such as salts providing ions with a high EM are also possible in the context of the instant invention.

The term “L medium” as used herein generally relates to a medium comprising a leader L (provided that the EM of the leader L is higher than the EM of the analyte of interest and the spacers) and a counter ion for said leader L.

In one preferred embodiment of an anionic ITP separation, the leader L is derived from a strong acid such as HCl or H₂SO₄, i.e., the leader L is chloride or sulfate. Generally, every strong acid or compound producing a negatively charged ion under the working conditions of an ITP separation in accordance with the present invention is suitable to act as an anionic leader electrolyte.

In a preferred embodiment of a cationic ITP separation, the leader L is derived from a strong base such as an alkali hydroxide or an earth alkaline hydroxide. Regardless of the source from which the leader L is derived, it is preferred that the leader L of a cationic ITP separation is an alkaline or an earth alkaline metal ion. Most preferably, e.g. for biological samples, the leader L is sodium (Na⁺) or potassium (K⁺).

In addition to said strong acid or strong base, it is most preferred that the L medium in accordance with the present invention additionally comprises a buffer compound. The buffer compound may be a buffer acid if the leader electrolyte is a strong base (i.e. in a cationic ITP separation), or it may be a buffer base if the leader electrolyte is a strong acid (i.e., in an anodic ITP separation). Said buffer compounds are suitable, if required, for adjusting the pH of a leader zone essentially to the pH value of the S zone. It should be understood that the buffer compound is selected in accordance with the preferred separation conditions such as the preferred pH and/or the ability to conserve the biological activity of analytes of interest. Optionally, the leader medium may comprise further additives.

In certain preferred embodiments of the present invention, the concentration of the buffer compound is about a factor of 1.0 to 4.0, preferably about a factor of 1.2 to 3.0, and more preferably about a factor of 1.8 to 2.2 higher than the concentration of the protons of said strong acid or the hydroxide ions derived from said strong base from which L is derived. In a particularly preferred embodiment, the concentration of the buffer compound is about a factor of 2 higher than the concentration of the protons of said strong acid or hydroxides of said base, respectively. For example, the concentration of a buffer base is then twice the concentration of HCl if chloride is L, or the concentration of a buffer base is four times the concentration of H₂SO₄ (if sulfate is L).

It should further be understood that the concentration of the leader electrolyte (leader L and its counter ion) is preferably chosen so as to ensure a suitably high electrical conductivity required to carry out an ITP separation in accordance with the present invention.

The term “buffer compound” as used herein is to be understood as a compound such as a weak acid or a weak base, respectively, having a pKa that is about equal to the pH suitable for carrying out an ITP separation according to the present invention. Accordingly, the terms “buffer acid” and “buffer base” preferably includes weak acids or bases, respectively, wherein a pKa value is about equal to the pH of the sample and separation medium in an ITP separation.

Accordingly, in one preferred embodiment of the present invention, the pH of an L medium is about equal to a pKa value of the buffer base if the ITP separation is an anionic ITP separation, or is about equal to a pKa value of the buffer acid if the ITP separation is a cationic ITP separation.

A preferred concentration of L within an L medium according to the present invention is selected from, but not limited to, the group consisting of at most about 50 mM, at most about 10 mM, at most about 5 mM, at most about 3 mM, at most about 2 mM, and at most about 1 mM. The upper concentration of L, and therefore the concentration of the leader electrolyte, is in practice often limited in view of the finite solubility of the buffer compound in the leader medium, since said buffer compound preferably has a higher concentration in an L medium compared to the concentration of the leader electrolyte, and may even be increased in a L stabilizing medium as will be described below.

The novel method of the present invention comprises the use of at least one L stabilizing medium. Thus, the term “L stabilizing medium” refers to a medium capable of forming an L stabilizing zone within an apparatus suitable to carry out an FF ITP separation. By virtue of its high electrical conductivity, the L stabilizing medium essentially prevents analytes and the leader L from migrating and contacting the electrodes during the FF ITP separation.

The increased conductivity in an L stabilizing medium compared to an L medium may be achieved by, e.g., adding a charged species I (wherein I is negatively charged when L is negatively charged and vice versa). The charged species I is provided together with its counter ion that should typically be the same counter ion as used for L, i.e., the counter ion typically derived from the buffer compound. Alternatively, the conductivity increase in the L stabilizing medium is accomplished by increasing the concentration of the buffer compound, or by increasing the concentration of the strong acid or strong base, respectively, from which L is derived, within the L stabilizing medium compared to the concentration of L in the adjacent L medium.

The charged species I as understood in the context of the present invention should have an EM about equal to the EM of L. It will be appreciated, however, that the EM of I can be lower than the EM of L, provided it is still higher than the EM of the analyte of interest. Thus, in some embodiments of the present invention, the EM of I is at least about 50%, preferably at least about 70%, more preferably at least about 90% of the EM of L, and is most preferably about equal to the EM of L. A non-limiting example for an L/I system is a leader L in an L medium being chloride and the charged species I within an L stabilizing medium being formiate.

It is also to be understood that a combination of L and at least a second charged species I is suitable to increase the conductivity of an L stabilizing medium.

In one preferred embodiment of the present invention, an L stabilizing medium does not comprise the leader L. In such a medium, L is completely substituted by I and furthermore, the concentration of I is increased in regard to the concentration of L within an adjacent L medium.

As previously explained, the increased conductivity within an L stabilizing medium may be achieved by, e.g., increasing the concentration of L and/or adding a charged species I.

Accordingly, in a preferred embodiment of the present invention the concentration of L, the concentration of I, or the concentration of a combination of L and I within an L stabilizing medium is at least a factor of 2, at least a factor of 3, preferably at least a factor of 5, more preferably at least a factor of 10, or at least a factor of 15, or even at least a factor of 20 higher than the concentration of L in the adjacent L medium.

The typical conductivity of an L stabilizing medium may be increased by at least a factor 2, 3, 5, 10, 15, 20, 30 or even higher compared to the conductivity of an adjacent L medium forming an L zone within the separation zone of an electrophoresis chamber. In some embodiments, it is advantageous that the conductivity of the L stabilizing medium is about a factor of 15, or even a factor of 20 higher than the conductivity of the adjacent L medium.

Although the conductivity of the L stabilizing medium is generally higher than the conductivity of the L medium, the pH of the L stabilizing media may be greater, nearly equal to or lower than the pH of the adjoining L medium. Typically, the pH of the L stabilizing medium is adapted to be essentially the same as the pH of the L medium. Optionally, the L stabilizing medium may comprise further additives.

Especially for FF ITP, one or more essentially identical media can form a “zone” in accordance with the present invention, i.e., a zone within the electrophoresis chamber can be formed by one medium being introduced through one media inlet into said apparatus, or by a medium that is introduced through more than one media inlet into said apparatus, or it can be formed by a plurality of essentially similar media. The term “essentially similar media” as used herein should be understood in the context of a plurality of media, wherein the concentration of all compounds within each medium may merely differ by means of error in measurement or error in dilution. Therefore, a zone at the beginning of an ITP experiment (i.e. upon commencement of the electrophoretic separation) is defined by comprising essentially the same compounds at essentially the same concentration throughout the zone within a separation chamber.

It will be understood that after contacting two different zones, a “blending” or mixing of the compounds of each zone will take place at the borders of said zones. In accordance with the present invention, a T zone and a diluted T zone respectively will therefore comprise at least mainly the terminator T, an S zone will comprise at least mainly spacers S, an L zone will at least mainly comprise a leader L, and an L stabilizing zone will at least mainly comprise a leader L, a charged species I or any combination thereof “Mainly” as used in this context means at least 70%, preferably 80%, more preferably 90% or even 95% and refers to the (w/w) percentage of compounds L, T and S present in the medium (i.e., besides the solvent used for the medium, typically water).

It will be understood that the definition and boundaries of a zone refer to the ITP-relevant components T, S and L. Further compounds such as buffer compounds, viscosity enhancers and the like may be independently present in each zone in any suitable concentration.

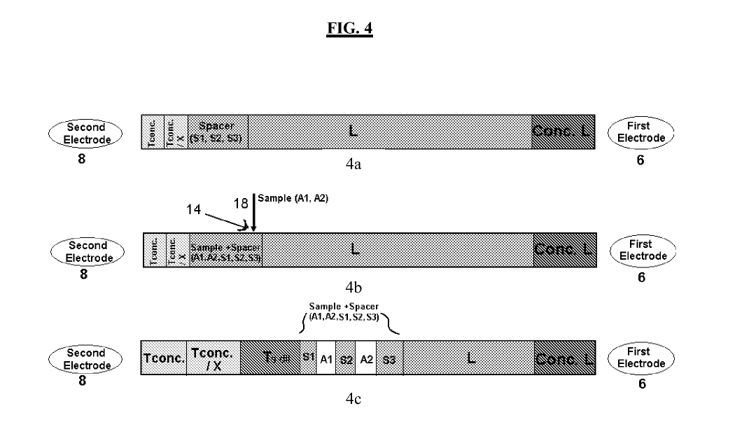

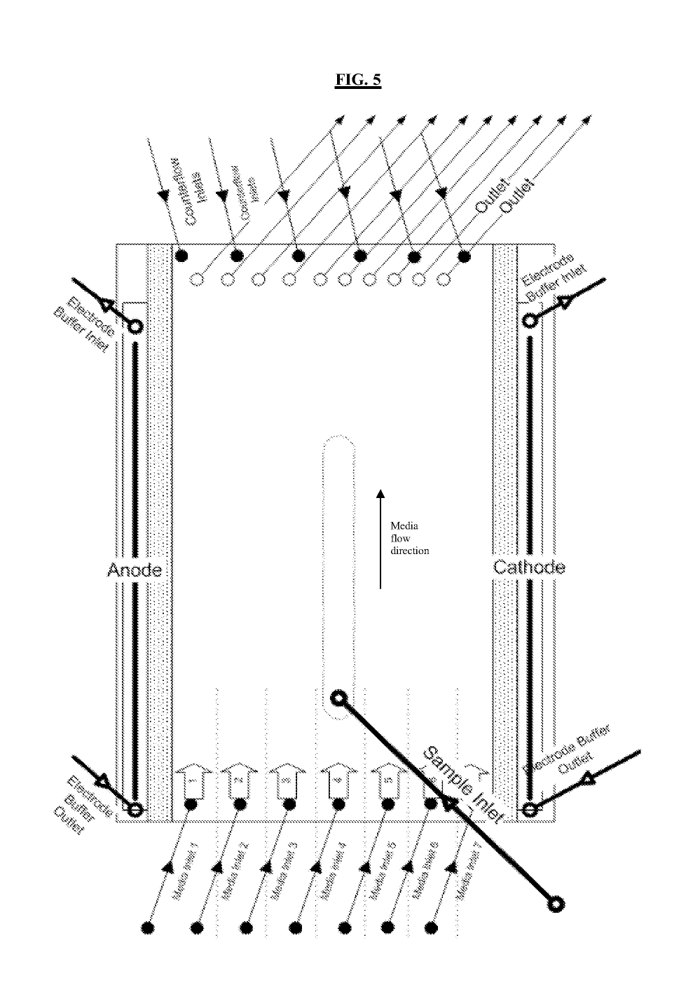

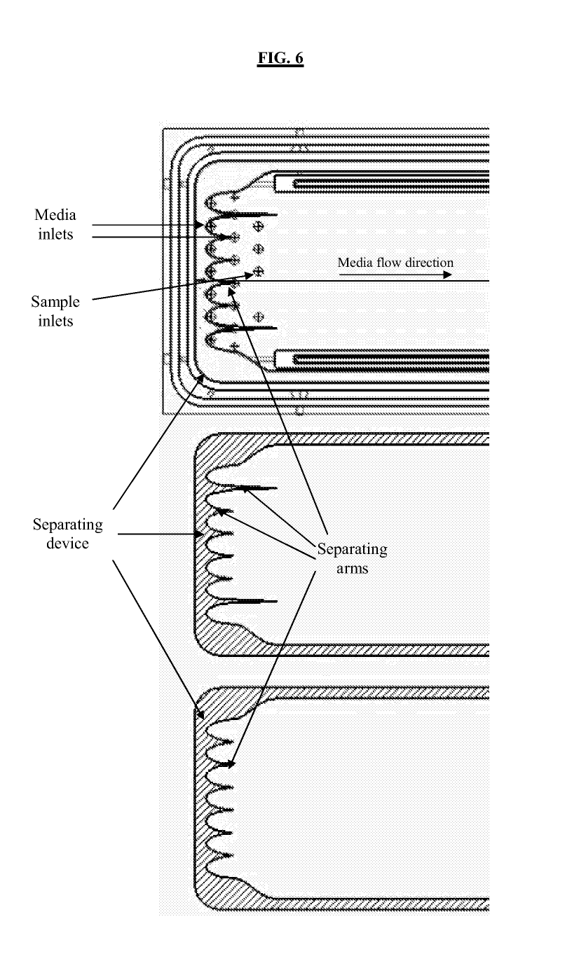

Furthermore, a zone in accordance with the present invention may be divided into several sub-zones when the compounds of said zone are subjected to an electrical field, i.e., when new zones are established. Such a segmentation of a zone, e.g., in free flow ITP is exemplified in FIG. 2. FIG. 2a shows an S&S zone consisting of a spacer and a sample medium comprising three different spacers S1, S2 and S3, and two analytes A1 and A2, which are homogenously distributed within the S&S zone. When subjected to an electrical field, five new zones will be formed, wherein each zone independently comprises mainly S1, mainly A1, mainly S2, mainly A2 and mainly S3, respectively, dependent on the respective EM of S1, S2, S3, A1, and A2.

The terms “separation chamber” and “electrophoresis chamber” are used interchangeably herein and relate to a chamber comprising typically two electrodes wherein the zone between the electrodes is referred to as “separation zone”. For free-flow electrophoresis, the media flow direction is typically perpendicular to the generally parallel electrodes, as, e.g., exemplified in FIGS. 3, 5 and 7. In other embodiments, such as for example those that may relate to capillary electrophoresis, the separation chamber may allow a media flow direction generally towards one of the two electrodes. Optionally, the electrodes in other contemplated embodiments may not necessarily be parallel to one another.

The term “separation zone” as used herein refers to the zone between the electrodes of an apparatus suitable to carry out an ITP separation according to the present invention. Such an apparatus may be suitable, e.g., to carry out a free-flow electrophoresis operation, procedure or method in a continuous or non-continuous manner, in arrangements similar to or comparable with continuous free-flow electrophoresis or optionally arrangements similar or compatible with or a capillary electrophoresis, respectively. Typically, a separation zone comprises a T zone, a diluted T zone, an S zone, an L zone and an L stabilizing zone.

The term “effective separation zone” as used herein refers to the zone between the electrodes of an apparatus suitable to carry out an ITP method according to the present invention formed by the S zone and the L zone. Since the spacers, analytes and leader ions will move towards the anode or cathode during an ITP separation, it will be appreciated that the effective separation zone will change its position and width as illustrated in FIG. 4.

The term “separation medium” as used herein means any medium that forms part of a separation zone, i.e., a T medium, a diluted T medium, an S medium, an L medium and/or an L stabilizing medium.

Although the embodiments described herein generally relate to any isotachophoresis technology, it will be appreciated that in certain particularly preferred embodiments the methods of the present invention are carried out as free-flow isotachophoresis. Accordingly, further embodiments of the present invention specifically relating to free flow isotachophoresis (FF ITP) will be described in more detail below.

FF ITP separation

One aspect of the present invention relates to a novel method for, e.g., separating at least one analyte of interest from a composition of analytes by free-flow isotachophoresis (FF ITP) comprising:
forming within an electrophoresis chamber a separation zone between a set of electrodes, wherein at least one of the electrodes is a cathode and at least one of the electrodes is an anode, comprising:
a terminator electrolyte (T) zone formed by at least one T medium; and
a diluted T zone, formed by at least one diluted T medium; and
a leader electrolyte (L) zone formed by at least one L medium; and
an L stabilizing zone, that is formed by at least one L stabilizing medium;
and, optionally, further comprising a spacer (S) zone formed by at least one S medium.

The electrophoretic mobility (EM) of an analyte of interest to be separated from a mixture of analytes should generally be known for a successful experiment. Accordingly, it may be necessary to determine the EM of the analytes (or any other compounds used in a separation medium) prior to carrying out the methods of the present invention. A person skilled in the art will generally know how to identify the EM of said analyte or compound of interest by means of well-established methods available in the art. Alternatively, the EM can also be determined experimentally by the methods described herein.

Generally, a sample to be subjected to an ITP separation is introduced together with a spacer medium prior to the establishment of equilibrium conditions between the different media. However, if the novel method is carried out as FF ITP, a sample may be introduced into a separation chamber downstream of the introduction point of the various media, for example after equilibrium conditions of the different media are already established. In this regard, it will be understood that the sample may generally be introduced at a position between the media inlets and the actual separation region (i.e., where an electric field is present between the electrodes), or can be placed directly within said field.

Additionally, preferably for FF ITP, it is noted that a sample can be introduced at different positions perpendicular to the bulk flow direction depending on the alignment of the different zones within a separation zone according to the present invention. Thus, a sample may be introduced into the S zone, or may alternatively be introduced between the S zone and the diluted T electrolyte zone. The sample may also be introduced into the diluted T zone, between the S zone and the L zone, or into the L zone.

Further, in one preferred embodiment of the present invention, the sample comprising an analyte of interest is introduced into the FFE chamber at a distance downstream of the introduction point of the separation media within a separation chamber. In other words, the sample is not introduced together with the spacers, but is rather introduced after equilibrium conditions of the different media have already been established. In certain embodiments the sample is introduced into the actual separation region (i.e., where an electric field is present between the electrodes).

Preferably, however, the sample is introduced at a position between the media inlets and the actual separation region between the electrodes of an apparatus suitable to carry out an FF ITP separation.

### Analytes

The ITP methods according to the present invention are suitable for analyzing at least one analyte of interest either within the separation zone, or after eluting the analytes from the separation zone and, optionally, after discharging at least one analyte from a separation chamber and optionally recovering at least one analyte of interest in one or a plurality of fractions.

The term “to analyze” as used herein is intended to include detection, quantification, studying or any other suitable examination of the analyte of interest.

In some embodiments it is preferred that at least the analyte of interest may be detected/analyzed within the separation zone, e.g., by means of UV/VIS- or fluorescence methods, conductivity detection, Raman spectroscopy, radioactivity measurement, pulsed amperiometry, circular dichroism, refraction index measurement, IR-spectroscopy or any combination thereof. In other embodiments, at least one analyte of interest can be analyzed by the same techniques after being eluted from a separation zone.

In the context of the present invention, a sample may be fractionated by means of isotachophoresis, including FF ITP. A fractionated sample means a sample wherein the various analytes in the sample are separated during an ITP separation and wherein the sample can thus be divided into several fractions after the ITP separation. For example, in embodiments relating to FF ITP, those of skill in the art will understand how to collect or recover individual fractions which exit the separation chamber of an apparatus suitable for FF ITP through multiple collection outlets and are generally led through individual tubings to individual collection vessels of any suitable type (e.g., 96 well plates, and sometimes plates of different sizes, e.g., 144, 288, 576 or even more wells). It is to be understood that at least part of a sample subjected to an ITP separation is collected in one or more than one fractions after said electrophoretic separation.

In certain embodiments, it might be suitable to collect not only the analyte/analytes of interest, but also at least one further or a plurality of further analytes besides the analyte(s) of interest. Therefore, regardless whether said analyte/analytes will be analyzed or otherwise used in any downstream applications, it/they may be recovered in one or a plurality of fractions from the ITP separation experiment.

In this regard, possible downstream analyses may be selected from, but not limited to the group consisting of (further) free-flow electrophoresis, gel electrophoresis, 1D- and 2D-PAGE, MS, MALDI MS, ESI MS, SELDI MS, LC-MS(/MS), MALDI-TOF-MS(/MS), ELISA, IR-spectroscopy, UV-spectroscopy, Raman spectroscopy, HPLC, Edman sequencing, NMR spectroscopy, surface plasmon resonance, radioactivity measurement, pulsed amperiometry, refraction index measurement, X-ray diffraction, nucleic acid sequencing, electro blotting, amino acid sequencing, flow cytometry, conductivity detection, circular dichroism, activity tests, and any combination thereof.

It is generally most preferred to recover an analyte of interest in merely one fraction comprising as little separation buffer as possible, i.e., it is most preferred that the analyte of interest elutes merely through one outlet of an apparatus suitable to perform a method according to the present invention. For example, when an FFE apparatus suitable to perform a method according to the present invention has standardized 96 outlets, it is most preferred that the analyte of interest elutes merely through one outlet, although the analyte of interest may also be eluted from the separation zone and discharged through two, three or more outlets, i.e., it would be present in more than one fraction. In other embodiments of the present invention, it is preferred that the analyte of interest may elute from the separation zone and be instantly subjected to a subsequent analysis without being collected within a single fraction.

In ITP, it is generally preferred when the effective separation zone formed by the (optional) S zone and L zone within a separation zone between the electrodes is as wide (in case of an FF ITP separation) or long (in case of a capillary ITP) as possible to allow an optimal separation. Nevertheless, especially in FF ITP, one cannot extend the effective separation zone over the whole width/length of the separation zone since at least a T and a diluted T zone according to the present invention have to be present in accordance with the present invention.

As used herein, the width of a particular zone in, e.g., FF ITP typically means the width of a zone in a 90° angle to the bulk media flow direction as illustrated in FIGS. 3 and 4. Similarly, the length of a zone in separation methods such as capillary ITP is the length of a zone in a, e.g., capillary or other suitable container between two electrodes. Therefore, the terms “width” and “length” are used interchangeably herein when referring to the width/length of a zone according to the present invention.

In one preferred embodiment, the width of the effective separation zone upon commencement of the electrophoretic separation is equal to or greater than 45%, greater than 60%, greater than 75%, greater than 80%, or greater than 90% of the width of the entire separation zone between the.

In another preferred embodiment of the present invention, the S zone and the L zone form the effective separation zone within the separation zone, and a width of said L zone upon commencement of the electrophoretic separation is at least a factor of 5, at least a factor of 8, at least a factor of 9, at least a factor of 10, at least a factor of 15 or even at least a factor of 20 broader than a width of said adjacent S zone.

Furthermore, in other preferred embodiments, a width of the S zone is essentially similar to a width of the diluted T zone upon commencement of the electrophoretic separation. To obtain optimal separation results, it is preferred to introduce the S zone having a small width into an apparatus suitable to carry out an ITP separation.

Although it is preferred to produce a diluted T zone and an (optional) S zone each having a width as small as possible, and therefore essentially equal, the width of said zones may vary by a factor of 0.1 to 10, more preferred by a factor of 0.2 to 5, or even by a factor of 0.3 to 3 from each other.

In some embodiments, especially in FF ITP, it is furthermore preferred that upon commencing the electrophoretic separation the width of the T zone between an electrode and the diluted T zone is at least about the same as the combined width of the diluted T zone and of the adjacent S zone, or is at least about a factor of 1.1, at least about a factor of 1.5 or even at least a factor of 2 greater than said combined width.

When separating analytes, e.g., sensitive analytes such as organelles, it may be advisable that the different media forming the different zones according to the present invention are brought to a distinct pH value required, e.g., for the integrity of the analytes. Therefore, in one preferred embodiment of the present invention, the pH of a diluted T medium is about equal to the pH of the T medium.

It will be appreciated that the pH of a solution may slightly change during the dilution of a buffer system, or that the pH may slightly vary when two similar buffer media are produced in parallel. Moreover, additives that are present at the same concentration in the T medium and in the diluted T medium (whereas the buffer system is present at a lower concentration in the diluted T medium) may also affect the pH of the diluted medium compared to the undiluted T medium.

Regardless of the reason for the potentially different pH values, it is generally preferred that the pH difference does not exceed 1 pH unit. Preferably, the difference should not exceed 0.5 pH units, more preferably it should not exceed 0.2 pH units and most preferably it essentially does not change at all, i.e. the difference is at a maximum 0.1 pH units.

Although an essentially constant pH is preferred throughout the different zones of a separation zone, the pH value may furthermore slightly change from the T medium to the L medium.

Therefore, in another preferred embodiment, the pH of an optional S medium is between the pH of an adjacent diluted T medium and the pH of an adjacent L medium. It is noted, that the pH will decrease from a diluted T medium to an L medium if the ITP separation is an anionic ITP separation and vice versa if the ITP separation is a cationic ITP separation. Generally, the maximum pH difference between the pH of a diluted T medium forming a diluted T zone and the pH of an L medium forming an L zone (wherein the pH of an S medium forming an S zone and located between the diluted T and the L zone is between said two pH values) should be less than 2 pH units, preferably less than 1 pH unit, more preferably less than 0.5 pH units and most preferably less than 0.2 pH units. Although it is preferred that the pH of an L stabilizing medium forming an L stabilizing zone is also essentially the same as the pH of an L medium forming an L zone, the two pH values may in practice nevertheless differ. It is also preferred that the pH of a diluted T medium is about equal to the pH of the T medium, although here again, good results may also be achieved even when the pH differs between the latter two media.

In yet other preferred embodiments, the conductivity of the different zones within a separation zone should have a distinct relation to each other to ensure a high resolution of the separation.

Therefore, in another embodiment, the conductivity of a diluted T medium is about equal to the conductivity of an adjacent S medium. An about equal conductivity is advantageous since the absence of a distinct conductivity step at the border between the two zones forming the effective separation zone reduces for example the disturbances in the electrical field, or the effects caused by differential heating.

It will be appreciated that there are several ways to achieve an about equal conductivity. For example, the concentration of the leader L and its counter ion that is derived from the buffer compound and the concentration of the buffer compound are adapted such that the conductivity of an L zone is essentially equivalent to the conductivity of an optionally present S zone. Alternatively, the concentrations of the different spacers can be adjusted so that the conductivity of an S medium forming an S zone possesses the same conductivity as an adjacent L zone, or a strong base or strong acid is introduced into the S medium to achieve a conductivity about equal to the conductivity of an adjacent L zone.

The term “about equal” as used in combination with the conductivity of different media or zones, respectively, preferably means a difference in conductivity between two adjacent zones of at most 10% or, more preferably, of at most 5% (with the higher conductivity taken as a basis).

In yet other embodiments, the conductivity of an S medium is adjusted to be about equal to the conductivity of an adjacent L medium using the same principles as described above.

Accordingly, one particularly preferred embodiment relates to an ITP method according to the present invention wherein the conductivity of a diluted T medium, an S medium and an L medium are all about equal.

With regard to free-flow electrophoresis, a number of operation modes are known to those of skill in the art and are contemplated in the context of the present invention. Accordingly, the novel methods of the instant invention—may be carried out in accordance with all known FFE operation modes as described in further detail below.

For example, the sample and the separation media may be continuously driven towards the outlet end while applying an electrical field between the anode and the cathode of an FFE apparatus (“continuous mode” FFE). Continuous mode in the context of FFE should be understood to mean that the injection step as well as the separation step occurs continuously and simultaneously. With the separation methods of the present invention, the electrophoretic separation occurs while the medium and the analytes pass through the electrophoresis chamber where the different species are being separated according to their electrophoretic mobility (ITP). Continuous mode FFE allows continuous injection and recovery of the analytes without the need to carry out several independent “runs” (one run being understood as a sequence of sample injection, separation and subsequent collection and/or detection). It will be appreciated that continuous mode FFE includes separation techniques wherein the bulk flow rate is reduced (but not stopped) compared to the initial bulk flow rate while the analytes pass the separation space between the electrodes in order to increase the separation time. In the latter case, however, one can no longer speak of a true continuous mode because the reduction of the bulk flow rate will only make sense when employing a limited amount of a sample.

Another FFE operation mode known as the so-called “interval mode” in connection with FFE applications has also been described in the art and is likewise contemplated herein. For example, a process of non-continuous (i.e. interval) deflection electrophoresis is shown in U.S. Pat. No. 6,328,868, the disclosure of which is hereby incorporated by reference. In this patent, the sample and separation medium are both introduced into an electrophoresis chamber, and then separated using an electrophoresis mode such as zone electrophoresis, isotachophoresis, or isoelectric focusing, and are then finally expelled from the chamber through fractionation outlets. Embodiments of the '868 patent describe the separation media and sample movement to be unidirectional, traveling from the inlet end towards the outlet end of the chamber. This direction, unlike in traditional capillary electrophoresis, is shared by the orientation of the elongated electrodes. In the static interval mode described for example in the '868 patent, acceleration of the sample between the electrodes caused by a pump or some other fluidic displacement element only takes place when the electrical field is off or at least when the voltage is ineffective for electrophoretic migration, i.e., when no part of the sample is being subjected to an effective electric field.

In other words, the interval process is characterized by a loading phase where the sample and media are introduced into the separation chamber of the electrophoresis apparatus, followed by a separation process where the bulk flow of the medium including the sample is halted while applying an electrical field to achieve separation. After separation/fractionation of the sample, the electrical field is turned off or reduced to be ineffective and the bulk flow is again turned on so that the fractionated sample is driven towards the outlet end and subsequently collected/detected in a suitable container, e.g., in a micro titer plate.

The so-called cyclic mode or cyclic interval mode in the context of FFE as used herein has been described in International application PCT/EP2007/059010 (claiming priority from U.S. provisional applications U.S. Ser. No. 60/823,833 and U.S. Ser. No. 60/883,260), which is hereby incorporated by reference in its entirety. In sum, the cyclic interval mode is characterized by at least one, and possible multiple reversals of the bulk flow direction while the sample is being kept in the electrophoretic field between the elongated electrodes. In contrast to the static interval mode, the sample is constantly in motion thereby allowing higher field strength and thus better (or faster) separation. Additionally, by reversing the bulk flow of the sample between the elongated electrodes, the residence time of the analytes in the electrical field can be increased considerably, thereby offering increased separation time and/or higher separation efficiency and better resolution. The reversal of the bulk flow into either direction parallel to the elongated electrodes (termed a cycle) can be repeated for as often as needed in the specific situation, although practical reasons and the desire to obtain a separation in a short time will typically limit the number of cycles carried out in this mode.

Accordingly, in preferred embodiments, an FF ITP separation according to the present invention may be operated in continuous mode, static interval mode, or cyclic interval mode.

In addition, counterflow media may be used to optimize the separation conditions of FF ITP as described in further detail in co-pending International application WO 2006/119001, which is hereby incorporated by reference in its entirety.

### Capillary ITP Separation

Another aspect of the present invention relates to a capillary ITP method for separating at least one analyte of interest from a composition of analytes comprising:
providing an apparatus suitable to carry out a capillary electrophoretic separation comprising two electrodes and a separation zone interposed therebetween, wherein said separation zone is formed by at least:
   a leader electrolyte (L) medium forming an L′ zone; and
   a spacer (S) medium forming an S zone; and
   a modified terminator electrolyte (T′) medium forming a T′ zone.

Said method is preferably suitable for capillary ITP, although it will be appreciated that other ITP methods may also benefit from the novel ITP separation method described herein.

Typically, a sample to be separated will be introduced along with an S medium. Alternatively, said sample could also be introduced into a capillary between the L medium and the S medium, between the S medium and the T′ medium, or along with the T′ medium although the latter case is not preferred.

The leader electrolyte (L) medium forming the L′ zone is equivalent to the L medium forming the L zone as described for the FF ITP separation. It will be understood that the L′ zone is essentially equal to the L zone formed during an FF ITP separation with the proviso that the L′ zone within a capillary is formed by merely one L medium.

The spacer (S) medium as used in the context of capillary ITP is generally equivalent to the spacer (S) medium described for the FF ITP method of the present invention.

The modified terminator electrolyte (T′) medium is essentially equivalent to the T medium as set forth for the FF ITP separation with the proviso that the conductivity of the T′ medium will be essentially adapted to the conductivity of the S medium of a capillary ITP. In other words, the concentrations of T and the strong acid or strong base, respectively, will be more similar to the diluted T medium compared to the situation described in the context of a free-flow ITP separation.

Accordingly, the term “T′ medium” as used herein relates to a medium comprising a terminator T as previously defined and a strong acid or base, respectively. A T′ medium suitable to carry out an anionic capillary ITP separation therefore comprises the terminator T and a strong base (e.g., NaOH). Optionally, the medium may further comprise additives.

A person skilled in the art will understand that the terminator T must be selected in accordance with the preferred separation conditions. The terminator T may be an acid, a base, a salt, or any compound whereof at least a fraction of said compound carries a net charge under the conditions suitable to carry out an ITP separation according to the present invention.

In more preferred embodiments, the terminator T is a buffer compound. The pH of a T′ medium is advantageously chosen to be about equal to a pKa value of T, i.e. the terminator T is preferably chosen so that its pKa is about the pH of the intended T′ medium so as to achieve an optimal buffering capacity of said T medium.

The terminator T for an anionic capillary ITP separation is usually selected from a buffer acid, wherein a pKa of said buffer acid is preferably higher than a pKa of the buffer base in the anodic leader medium. The concentration of the strong base added to the cathodic T′ medium is preferably lower than the concentration of the buffer acid in the same medium, but high enough to ensure a high degree of ionization in order to achieve the desired high conductivity. Preferably, the strong base is an alkali metal hydroxide or an alkaline earth metal hydroxide. In certain particularly preferred embodiments of this aspect of the present invention, the strong base is sodium hydroxide (NaOH) or potassium hydroxide (KOH).

It is generally preferred that the concentration of said strong base is about a factor of 1.0 to 4.0, preferably about a factor of 1.2 to 3.0, and more preferably about a factor of 1.8 to 2.2 less than the concentration of T within a T′ medium. It is even more preferred that the concentration of said strong base is about a factor of 2 less than the concentration of T within a T′ medium to achieve an optimal buffer capacity of said T.

T compounds suitable to perform ITP such as HEPES and Morpholinoethanol are generally known to the skilled artisan. Together with the teaching provided herein, the person skilled in the art will be able to select a suitable terminator T for carrying out an capillary ITP separation according to the present invention.

Accordingly, a T′ medium suitable to carry out a cationic ITP according to the present invention comprises the terminator T and a strong acid such as formic acid, hydrochloride or sulfuric acid. Optionally, the medium may comprise further additives.

In preferred embodiments, the pH of a T′ medium is about equal to a pKa of T, i.e. the terminator T is preferably chosen so that its pKa is about the pH of the intended T′ medium so as to achieve an optimal buffering capacity of the T′ medium.

The concentration of the strong acid added to the anodic T′ medium is preferably lower than the concentration of the buffer base in the same medium, but high enough to ensure a high degree of ionization in order to achieve the desired high conductivity. To achieve a good buffering capacity of the T′ medium, it is most preferred that the concentration of said strong acid is about a factor of 1.0 to 4.0, preferably about a factor of 1.2 to 3.0, or more preferably about a factor of 1.8 to 2.2 smaller than the concentration of T within a T′ medium. In even more preferred embodiments, the concentration of said strong acid is about a factor of 2 less than the concentration of T within a T medium in order to achieve a maximum buffer capacity of said terminator T.

Again, the skilled person will understand how to select a suitable terminator T to carry out an ITP separation according to the present invention. Because of the advantageous properties of the T′ medium according to the present invention, it will be appreciated that said medium is particularly useful for capillary ITP methods.

In a capillary ITP separation, an analyte of interest may be detected/analyzed via “on column” detection/analysis within the separation capillary, e.g., by means of UV/VIS- or fluorescence methods, or “post column” detection/analysis at the end of the capillary are possible. “Post column” detection can be selected from but are not limited to the group consisting of UV/VIS- or fluorescence methods, conductivity detection, MS analysis, Raman spectroscopy, radioactivity measurement, pulsed amperiometry, circular dichroism, and refraction index measurement. Furthermore, the analyte(s) of interest may optionally be eluted and at least one analyte of interest may be recovered in one or a plurality of fractions. A downstream analysis may be equivalently performed with at least one fraction as is previously discussed for a fraction derived from an FF ITP separation.

In general, a capillary suitable for carrying out capillary electrophoresis is dipped into a source and a destination vial, respectively. In some preferred embodiments, the electrolyte medium of the source chamber is a concentrated T′ medium whose concentration is at least a factor 2, at least a factor 3, preferably at least a factor 5, more preferably at least a factor 10, or even at least a factor 15 higher than the concentration of the T′ medium, and/or the destination electrolyte medium is an L stabilizing medium as defined herein in the context of an FF ITP separation.

It will be appreciated that capillary electrophoresis as referred to herein includes both, carrier-less (i.e. free solution), and carrier-based (e.g. gel) capillary electrophoresis, and in particular capillary isotachophoresis.

### Additives

The separation media suitable for the ITP methods of the present invention may comprise one or more additives. Generally, the number and concentration of additives should be kept to a minimum, although it will be appreciated that certain analytes or separation problems require the presence of additional compounds either for maintaining analyte integrity or for achieving the desired properties of the medium (e.g., viscosity adaptation between various separation media, etc.).

Possible additives are preferably selected from other acids and/or bases, so-called “essential” mono- and divalent anions and cations, viscosity enhancers, affinity ligands, and the like.

Essential mono- and divalent anions and cations in the sense of the present application are ions that may be needed for maintaining the structural and/or functional integrity of the analytes in the sample. Examples for such essential anions and cations include, but are not limited to magnesium ions, calcium ions, zinc ions, Fe(II) ions, chloride ions, sulfate ions, phosphate ions or complexing agents such as EDTA or EGTA, or azide ions (e.g., for avoiding bacterial contamination), and the like.

Examples for possible acids and bases include small amounts of strong acids or bases (e.g., NaOH, HCl, etc.) that are completely dissociated in solution, e.g., to enhance the conductivity of an S medium.

Viscosity enhancers commonly used in the separation media may include polyalcohols such as glycerol or the various PEGs, hydrophilic polymers such as HPMC and the like, carbohydrates such as sucrose, hyaluronic acid, and the like. Viscosity enhancers may be required to adapt the viscosity of the separation medium to the viscosity of the sample introduced into the separation space, or to the viscosity of other separation and/or stabilizing media within the separation chamber in order to avoid turbulences created by the density or viscosity differences between sample and medium or between different adjacent media.

Additional additives that may be present include chiral selectors such as certain dextrins including cyclodextrins, or affinity ligands such as lectins and the like.

In certain cases, it may be required to add reducing agents to prevent the oxidation of an analyte in the solution. Suitable reducing agents that may be added to the sample and/or the separation medium includes mercaptoethanol, mercaptopropanol, dithiothreitol (DTT), ascorbic acid, sodium or potassium metabisulfite, and the like.

In any event, because many of the aforementioned additives are electrically charged, their concentration should be kept as high as needed but at the same time as low as possible because they represent additional species in the separation space that are electrophoretically manipulated during the ITP experiment.

### Kits

It will be apparent to those skilled in the art that the terminator (T) media/diluted terminator (T) media and leader (L) media contemplated herein may be selected, prepared and used alone, or, alternatively, together with suitable L stabilizing media and spacer S media, respectively.

Accordingly, another aspect of the present invention relates to a kit for carrying out an isotachophoresis (ITP) method, which comprises at least one of the novel T media described herein. Preferably, the kits are for carrying out a separation by free-flow isotachophoresis.

Kits for carrying out an ITP separation may further comprise at least one diluted T medium in addition to said T medium. As previously described, a diluted T medium may be derived from a T medium by simple dilution, or it may be separately prepared, and may optionally comprise further additives in various concentrations.

In one embodiment of this aspect of the invention, the kit may further comprise a spacer (S) medium, or an assortment of spacers that are to be combined so as to obtain a spacer mixture/spacer medium adapted for the separation of a distinct analyte. A person skilled in the art will understand how to select and mix spacers in view of the electrophoretic mobility (EM) of the analyte of interest so as to obtain a spacer mixture that assists in the separation of said analyte from other analytes.

In another embodiment, a kit may further comprise at least one L medium. An L medium according to the present invention is preferred. It should be understood that an L medium comprised within a kit according to the present invention may be used to form an L zone that is much broader than an S, a T, a diluted T or an L stabilizing zone, i.e. the L zone is preferably formed by adding the L medium through a multiplicity of inlets. Therefore, it will be understood that an L medium will be delivered preferably in a volume/amount that is at least 2 times, at least 4 times, at least 6 times, at least 8 times, at least 10 times, at least 12 times, or at least 14 times of the volume/amount of a delivered T medium.

In yet another embodiment, a kit may further comprise at least one L stabilizing medium. An L stabilizing medium as defined in the present invention is preferred. It will be understood that an L stabilizing medium can be an anodic or a cathodic L stabilizing medium, depending on the charge of the analyte to be separated.

Another aspect relates to a kit for carrying out a capillary ITP separation according to the present invention comprising at least a T′ medium as defined hereinabove in the context of a capillary ITP separation method.

In a preferred embodiment, such a kit further comprises an L medium, preferably an L medium as defined in the present invention.

In another embodiment, such a kit may further comprise a spacer S medium or an assortment of spacers that are to be combined so as to obtain a spacer mixture/spacer medium adapted for the separation of a distinct analyte. A person skilled in the art will understand how to select and mix spacers in view of the EM of the analyte of interest so as to obtain a spacer mixture that assists in the separation of said analyte from other analytes.

In particularly preferred embodiments, the kits of the present invention will further comprise a product manual that describes at least one or more experimental FF ITP protocols or capillary ITP protocols, respectively, and optionally storage conditions for the kit components.

In other preferred embodiments, a kit will include at least all media required for an FF ITP separation according to the present invention, i.e., a T medium, a diluted T medium, an S medium, an L medium and an L stabilizing medium or for a capillary ITP according to the present invention, i.e. a T′ medium, an S medium and an L medium.

In any of the previous embodiments, the kits may comprise one or several of the media of the present invention, as well as any additional media, such as counter flow media, in the form of one or more aqueous solutions that are ready to be used (i.e. all components are present in the desired concentration for the FF ITP experiment), or they may comprise one or several of the media in the form of a concentrated solution (stock solution) that is to be diluted with a pre-determined amount of solvent prior to their use. In the latter case, a concentrated solution may have a concentration that is 1.5×, 2×, 2.5×, 5×, 10×, 20×, 25×, 50×, 75×, 100×, 150×, 200×, or 1000× higher compared to the respective ready-for-use solution.

Alternatively, the kit may comprise one or several media in dry form or lyophilized form comprising the various ingredients of a medium in several, but preferably in one, container which is then reconstituted with a predetermined amount of solvent prior to its use in an electrophoretic separation process.

Preferably, each medium (T medium, diluted T medium, S medium, L medium and L stabilizing medium) will be present in a separate container, although it will be apparent to those of skill in the art that other combinations and packaging may be possible and useful in certain situations. For example, it has been mentioned above that a T medium and a diluted T medium may merely differ by having different concentrations of the ingredients. In the latter case it may be beneficial to deliver a T medium and an empty container to dilute a part of said T medium.

It is contemplated that all of the separation media and stabilizing media described herein, whether preferred or not, may be included in any possible and suitable combination in the kits of the present invention.

Optionally, the kits of the present invention may further comprise instructions for the use of the kit components in the isotachophoresis applications of the present invention.

### Apparatus for Carrying out the ITP Methods of the Present Invention

Another aspect of the present invention relates to an apparatus suitable for performing an electrophoretic method according to the present invention. Such an apparatus comprises:
an electrophoresis chamber comprising a set of electrodes, wherein at least one of the electrodes is a cathode and at least one of the electrodes is an anode, and a separation zone interposed therebetween,
wherein the apparatus further contains means for forming
a terminator electrolyte (T) zone containing at least one T medium;
a diluted T zone containing at least one diluted T medium;
a leader electrolyte (L) zone containing at least one L medium; and
an L stabilizing zone at least one L stabilizing medium
within said separation zone

In preferred embodiments, the apparatus further contains means for forming a spacer

(S) zone formed by at least one S medium. The spacer (S) zone is preferably located between the diluted T zone and the leader electrolyte (L) zone.

It will be understood that such an apparatus is especially adapted for performing a method according to the present invention, e.g., a capillary or free flow isotachophoretic separation.

In preferred embodiments, the apparatus is suitable for performing a separation of at least one analyte of interest from a composition of analytes by ITP. In certain embodiments of this aspect, the apparatus is an FFE apparatus suitable for separating analytes by free-flow isotachophoresis (FF ITP).

Embodiments of an apparatus adapted to perform an FF ITP method will be described in more detail below.

### Apparatus for Carrying out FF ITP and Elements Thereof

An apparatus suitable for “classic” FFE is represented in FIG. 5. The position of the sample inlet in FIG. 5 is S4, being placed in the vicinity of media inlet 4. Accordingly, a sample inlet S2 would be positioned at media inlet 2.

In FFE applications, the apparatus will typically comprise several media inlets (e.g., N=7, 8, or 9 inlets), so that the media forming the separation zone between the electrodes may be introduced through maximum N inlets. The number of separation media, which can be inserted into an apparatus suitable for FFE, is typically between 2 and 15, preferably between 3 and 12 and most preferably between 4 and 9.

The inside bore diameter of each media inlet of a “classic” FFE apparatus is equal. The media inlets are situated between the electrodes and have an equal distance to each other. Furthermore, a separating device as, e.g., shown in FIG. 6 comprises separating arms that separate the media inlets from each other.

In contrast to the apparatus known in the art, the apparatus suitable to carry out an FF ITP separation according to the present invention comprises at least one separation chamber through which a multiplicity of media can flow and wherein said chamber(s) comprises inlets through which, e.g., media are introduced into the chamber, wherein said media inlets have different inside bore diameters and distances to each other.

Furthermore, an apparatus suitable to carry out an FF ITP separation according to the present invention may comprise a modified separating device to separate the media inlets from each other. A non-limiting schematic view of such a novel apparatus suitable to carry out an FF ITP separation is shown in FIG. 7.

In certain preferred embodiments of the present invention, an FFE apparatus suitable to carry out an FF ITP separation according to the present invention has at least 5 media inlets. Notably, the inside bore diameters “d” of two adjacent media inlets (the “a” inlets, see inlets 2 and 3 in FIG. 7) are less than the inside bore diameters “D” of the other media inlets (the “A” inlets). Generally, more than two “a” inlets may be present between the electrodes of an apparatus suitable to carry out an FF ITP separation, although it is preferred that only two adjacent “a” inlets are present. As a non-limiting example, said two adjacent media inlets are suitable to introduce a diluted T medium and an S medium that preferably form narrow diluted T and S zones. This effect can be further optimized by, e.g., varying the distances between several media inlets and by using special separation devices as will be discussed below.

Preferably, the inside bore diameters D for each of the “A” inlets are equal. It is furthermore preferred that at least one “A” inlet is located between the “a” inlets and each electrode. The inside bore diameters d of “a” inlets according to the present invention may be at most a factor of 0.8, preferably a at most factor of 0.65, and more preferably at most a factor of 0.5 compared to the inside bore diameter D of “A” inlets. As a non-limiting example, such an “A” inlet between an electrode and “a” inlets may be used to introduce a T medium into the separation chamber.

The number of inlets may vary depending on the apparatus but the number of “A” inlets is at least 3, preferably at least 4, more preferably at least 5, or most preferably at least 6. It is also preferred that the number of “A” inlets between one electrode and the “a” inlets is less than 3, preferably less than 2 and most preferably 1.

Therefore, in a particularly preferred embodiment one “A” inlet is situated between a electrode and two “a” inlets and the number of “A” inlets between the two “a” inlets and the other electrode is at least 2 but preferably as high as possible. Such an alignment is, e.g., suitable to introduce a T medium (“A” inlet), a diluted T medium (“a” inlet), an S medium (“a” inlet), at least one L medium (“A” inlet(s)) and an L stabilizing medium (“A” inlet) into a separation chamber.

Furthermore, the distance between the “a” inlets to each other is at most a factor of 0.8, preferably at most a factor of 0.65 and more preferably at most a factor of 0.5 compared to the distance between a pair of “A” inlets. Preferably, the difference between the distance between “a” inlets and the distance between “A” inlets correlates with the difference in the inside bore diameter of said “a” and “A” inlets, i.e., it is preferred that the distance between “a” inlets is essentially the same factor less compared to the distance between “A” inlets than d of “a” inlets compared to D of “A” inlets.

In another embodiment, an apparatus suitable to carry out an FF ITP separation according to the present invention comprises a separating device that contains separating arms which separate the inlets from each other. As illustrated in FIG. 7, the separating arms that separate the “a” inlets from each other and from the adjacent “A” inlets are notably longer than the separating arms separating the “A” inlets from each other.

Preferably, the separating arms that separate the “a” inlets from each other and from the adjacent “A” inlets have a length that is independently at least a factor 1.5, preferably at least a factor 1.8 and more preferably at least a factor 2 longer than the separating arms separating the “A” inlets.

In a preferred embodiment, the separating arms that separate the “a” inlets from each other and from the adjacent “A” inlets have essentially an equal length. “Essentially an equal length” as used in this context means that independently from each other each length of the three separating arms differs by at most a factor of 0.1 from the length of the other two separating arms.

A particularly preferred embodiment of the present invention relates to an FFE apparatus adapted to carry out an FF ITP separation having an electrophoresis chamber comprising a set of electrodes, wherein at least one of the electrodes is a cathode and at least one of the electrodes is an anode, and a separation zone interposed therebetween, wherein the apparatus comprises at least 5 inlets through which media are introduced into the chamber, and further contains means for forming
a terminator electrolyte (T) zone containing at least one T medium;
a diluted T zone containing at least one diluted T medium;
optionally a stabilizing (S) zone containing at least one S medium;
a leader electrolyte (L) zone containing at least one L medium; and
an L stabilizing zone at least one L stabilizing medium
within said separation zone
   wherein two adjacent “a” inlets have an inside bore diameter d of at most a factor of 0.8 compared to the inside bore diameter D of an “A” inlet, and wherein at least one “A” inlet is located between said two “a” inlets and each electrode; and further wherein the distance between said two adjacent “a” inlets is at most a factor of 0.8 of the distance between a pair of “A” inlets; and the distance between said two adjacent “a” inlets is at most a factor of 0.8 of the distance between a “a” inlet and an “A” inlet.

In other preferred embodiments, an apparatus of the present invention may comprise said two “a” inlets wherein the inside bore diameter d of said “a” inlets is at most a factor of 0.65, preferably at most a factor of 0.5 compared to D of said “A” inlets compared to the inside bore diameter D of an “A” inlet.

Furthermore, an apparatus according to the present invention may further comprise a separating device that contains separating arms which separate the inlets from each other and wherein the separating arms that separate said two adjacent “a” inlets from each other and from the adjacent “A” inlets independently have a length that is at least a factor 1.5, preferably at least a factor 1.8, more preferably at least a factor 2 longer than the separating arms separating the “A” inlets of said apparatus from each other.

In yet another preferred embodiment, an apparatus of the present invention may comprise a multiplicity of “A” inlets wherein the number of “A” inlets between one electrode of said apparatus and said “a” inlets is at least 2, preferably at least 4, more preferably at least 5, and most preferably at least 10, and the number of inlets between the other electrode of said apparatus and said two adjacent inlets is equal or less than 4, preferably equal or less than 2, and most preferably 1.

It is preferred to perform an isotachophoretic method, and particularly a free flow isotachophoresis (FF ITP) method according to the present invention, by using an apparatus of the present invention in order to achieve a separation of at least one analyte of interest from a composition of analytes.

Yet another embodiment relates to an apparatus comprising:
an electrophoresis chamber comprising a set of electrodes, wherein at least one of the electrodes is a cathode and at least one of the electrodes is an anode, and a separation zone interposed therebetween, wherein the separation zone is configured to include:
   a terminator electrolyte (T) zone;
   a diluted T zone;
   a leader electrolyte (L) zone; and
   an L stabilizing zone.

In a preferred embodiment, said apparatus additionally includes a spacer S zone. Said spacer S zone is most preferably situated between a diluted T zone and an L zone.

In preferred embodiments of this aspect of the invention, said apparatus is configured to separate at least one analyte of interest from a composition of analytes by free flow isotachophoresis (FF ITP).

In another preferred embodiment, said apparatus may include two adjacent “a” inlets having an inside bore diameter d of at most a factor of 0.8 compared to the inside bore diameter D of an “A” inlet.

In yet another preferred embodiment, at least one “A” inlet is located between said two “a” inlets and each electrode.

The apparatus may further comprise a separating device that contains separating arms which separate the inlets from each other, wherein the separating arms that separate two adjacent “a” inlets from each other and from the adjacent “A” inlets independently have a length that is at least a factor 1.5 longer than the separating arms separating the “A” inlets from each other.

As already previously mentioned, a sample to be separated according to an electrophoretic method of the present invention may be introduced into a separation chamber together with any separation medium that is introduced into said chamber through one of its the media inlets. Additionally, if the electrophoretic method is a free flow electrophoretic method, said free-flow electrophoretic method offers the advantage that a sample may be introduced through a separate, dedicated sample inlet into an FFE apparatus suitable to perform said method.

After being introduced into the electrophoresis chamber, e.g., of any of the afore-mentioned apparatuses, the various analytes in the sample within the separation medium are then separated by applying an electrical field while being fluidically driven towards the outlet end of the FFE apparatus. The individual analytes exit the separation chamber through the multiple collection outlets and are generally led through individual tubing to individual collection vessels of any suitable type. In the collection vessels, the analyte is collected together with the separation medium and counter flow medium (depending from the used apparatus). The distance between the individual collection outlets of the array of collection outlets should generally be as small as possible in order to provide for a suitable fractionation/separation. The distance between individual collection outlets, measured from the centers of the collection outlets, can be from about 0.1 mm to about 2 mm, more typically from about 0.3 mm to about 1.5 mm.

In various embodiments, the number of separation media inlets is limited by the design of the apparatus and practically ranges, e.g., from 1 to 7, from 1 to 9, from 1 to 15, from 1 to 40 or even higher depending on the number of media inlets chosen. The number of sample inlets ranges, e.g., from 1 to 36, from 1 to 11, from 1 to 5, from 1 to 4, or even from 1 to 3, whereas the number of collection outlets ranges, e.g., from 3 to 384, or from 3 to 96, although any convenient number can be chosen depending on the separation device. The number of counter flow media inlets typically ranges, e.g., from 2 to 9, or from 3 to 7. The number of provided inlets and outlets generally depends from the shape and dimensions of the separation device and separation space. Therefore, it will be appreciated that different numbers of separation media inlets and outlets are also possible.

In FIG. 5, a separation medium flows in a laminar manner (preferably from the bottom upwards in a tilted or flat separation chamber) between and along the length of both of the electrodes (large arrow). In some embodiments, the separation medium is decelerated by the counter flow of the separation medium (small arrow) in the vicinity of the outlets, and thus exits the separation chamber in fractions via the outlets, i.e. in some embodiments, a counter-flow medium is introduced into the separation space counter to the continuous flow direction of the bulk separation medium and sample that travels between the electrodes. Both media (separation media and counter flow media) are discharged or eluted through fractionation outlets.

A sample of, e.g., proteins to be separated is introduced into the separation medium via the sample inlet and transported by the laminar flow of the separation medium. When operated under continuous operating conditions, the protein mixture is continuously separated by electrophoretic migration under the influence of an electrical field between the electrodes, and collected in distinct fractions according to the properties of the separation buffer and the sample resulting from the electrical field generated between the electrodes in the separation medium. When operated under batch or discontinuous modes of operation, the sample may be collected into distinct fractions with a variable chamber size that can be adjusted depending on the characteristics and needs of the electrophoresis process.

It will be appreciated that all previously mentioned embodiments, whether specifically marked as preferred or not, are intended to be combined in any suitable way. Moreover, it will be apparent to those of skill in the art that many modifications to the embodiments described herein will be possible without departing from the scope and spirit of the present invention. The invention is now further illustrated by virtue of several non-limiting examples.

### Examples

### Example 1

### Separation of pI Markers Using an FF ITP Method According to the Present Invention and Comparison with a Prior Art Method

A free-flow electrophoresis apparatus was set up comprising eight media inlets (E1-E8) of varying bore inside diameters. Inlets E1-E5 and E8 were 0.64 mm while E6 and E7 were 0.38 mm. A stabilized leader containing HCl (100 mM) and morpholinoethanol (200 mM) was introduced into inlet E1. A less concentrated leader of HCl (10 mM) and morpholinoethanol (20 mM) was introduced into inlets E2 through E5. A spacer composition comprising MES (1 mM), MOPS (1.1 mM) and MOPSO (0.8 mM), and BISTRIS 20 mM to enhance the conductivity was introduced into inlet E6. A diluted terminator comprising NaOH (10 mM) and HEPES (20 mM) was introduced into inlet E7, and a non-diluted terminator comprising NaOH (50 mM) and HEPES (100 mM) was introduced into inlet E8. Free-flow continuous isotachophoresis was performed on a mixed sample of pI markers at a voltage of 700 V. The current was 34 mA. After electrophoretic separation, the sample and media were eluted into fraction collectors and the fractions were analyzed.

The colored pI-markers were separated to evaluate the separation performance of the system. The absorbance of the fraction at λ=420 nm, 515 nm, and 595 nm which represent the absorbance of the respective pI-markers are reported in FIG. 8.

The same experiment was performed according to a standard IPT protocol. A leader of HCl (10 mM) and morpholinoethanol (20 mM) was introduced into inlets E1 through E5. A spacer composition comprising MES (1 mM), MOPS (1.1 mM) and MOPSO (0.8 mM), and BISTRIS 20 mM was introduced into inlet E6. As a terminator, HEPES (10 mM) was introduced into inlets E7 and E8. Free-flow continuous isotachophoresis was performed on a mixed sample of pI markers at a voltage of 1000 V. The current was 13 mA. After electrophoretic separation, the sample and media were eluted into fraction collectors and the fractions were analyzed.

The colored pI-markers were separated to evaluate the separation performance of the system. The absorbance of the fraction at λ=420 nm, 515 nm, and 595 nm which represent the absorbance of the respective pI-markers are reported in FIG. 9.

As illustrated in FIGS. 8 and 9, the separation using the novel FF ITP method according to the present invention showed a much better resolution compared to the prior art separation method that generally uses the same leader, spacers, sample and terminator as the novel FF ITP method. As can be seen in FIG. 9, the prior art method yielded only a poor separation of the pI markers. All pI markers were detected between fraction 63 and fraction 82, in fact, most pI markers were detected in fractions 63 to 68. In contrast, the same mixture of pI markers that was separated using an FF ITP method according to the present invention elutes between fractions 22 to 92. Furthermore, it is noted that the various pI markers (each having a different absorbance maximum) were essentially isolated in different fractions.

### Example 2

### Separation of Peroxisomes with Interval FF ITP

In a second example, an FFE apparatus was set up comprising eight media inlets (E1-E8) of varying bore inside diameters. Inlets E1-E5 and E8 were 0.64 mm while E6 and E7 were 0.38 mm. A stabilized leader containing HCl (100 mM) and BISTRIS (200 mM) was introduced into inlet E1. A less concentrated leader of HCl (10 mM) and BISTRIS (20 mM) was introduced into inlets E2 through E5. A spacer composition comprising HAc (1.3 mM), lactic acid (1.0 mM), glucuronic acid (3.25 mM), ACES (2.0 mM), MOPSO (1.6), and BISTRIS (17 mM) were introduced into inlet E6. A diluted terminator comprising NaOH (10 mM) and HEPES (20 mM) was introduced into inlet E7, and a non-diluted terminator comprising NaOH (50 mM) and HEPES (100 mM) was introduced into inlet E8. As an additive to the mixed sample, sucrose (250 mM) was included. Free-flow isotachophoresis was performed at a voltage of 800 Volts with a sample comprising organelles (peroxisomes) that was pre-purified by centrifugation. The sample and media were introduced into the chamber at a flow rate of 180 mL per hour. During electrophoresis, the bulk flow rate of the media and sample between the electrodes was reduced compared to the introduced flow rate. For example, a bulk flow rate of the sample and media during separation between the electrodes was 80 ml per hour. After separation, the sample and media were eluted into fraction collectors such as a microtiter plate at an increased flow rate of greater than 80 mL per hour. This flow rate can increase to at least 180 ml per hour depending on the ability of the outlet portion of the chamber to maintain laminar flow conditions during elution. Total separation time was approximately 5 minutes and 50 seconds.

The absorbance of each fraction was measured at λ=420 nm. The absorbance peaks in certain fractions are caused by the presence of peroxisomes in the sample (see FIG. 10). The identity and integrity of the separated peroxisomes was confirmed by electron microscopy (FIG. 11), and by subsequent conventional gel electrophoresis (data not shown).

1-121. (canceled)

122. An electrophoresis method comprising:
providing an electrophoresis chamber comprising a set of electrodes, wherein at least one of the electrodes is a cathode and at least one of the electrodes is an anode, and a separation zone interposed between said electrodes,
configuring said separation zone to include:
a terminator electrolyte (T) zone formed by at least one T medium;
a diluted T zone, formed by at least one diluted T medium;
a leader electrolyte (L) zone formed by at least one L medium; and
an L stabilizing zone, formed by at least one L stabilizing medium.

123. The electrophoresis method according to claim 122, wherein said separation zone is configured to further comprise
a spacer (S) zone formed by at least one S medium;

124. The method according to claim 122, wherein the electrophoresis chamber is further configured to receive at least one analyte of interest.

125. The method according to claim 122, wherein said method is for separating at least one analyte of interest from a composition of analytes by ITP.

126. The method according to claim 122, wherein said separation zone is configured to further comprise a spacer (S) zone formed by at least one S medium; and wherein the S zone and the L zone form an effective separation zone within the separation zone, and wherein a width of said L zone upon commencing the electrophoretic separation is at least a factor 8 broader than a width of said adjacent S zone.

127. The method according to claim 122, wherein said separation zone is configured to further comprise a spacer (S) zone formed by at least one S medium and wherein a width of the effective separation zone upon commencement of the electrophoretic separation is equal to or greater than 45% of a width of the separation zone between said electrodes.

128. The method according to claim 122, wherein said separation zone is configured to further comprise a spacer (S) zone formed by at least one S medium and wherein a width of the S zone is about equal to a width of the diluted T zone upon commencement of electrophoretic separation, and further wherein a width of the T zone between an electrode and the diluted T zone is about equal to or greater than a combined width of the diluted T zone and the adjacent S zone upon commencement of the electrophoretic separation.

129. The method according to claim 122, wherein said method is an anionic ITP and L is derived from a strong acid, or wherein the method is a cationic ITP and L is derived from a strong base.

130. The method according to claim 122, wherein:
said T medium comprises T and a strong acid if the ITP is a cationic ITP, or a strong base if the ITP is an anionic ITP; and
T is a buffer compound; and
further wherein a concentration of said strong acid or strong base is about a factor 1.2 to 3.0 smaller than a concentration of T.

131. The method according to claim 122, wherein the pH of a T medium is about equal to a pKa of T.

132. The method according to claim 122, wherein a concentration of T in a diluted T medium is about a factor 2 to a factor 20 smaller than a concentration of T in an adjacent T medium.

133. The method according to claim 122, wherein said separation zone is configured to further comprise a spacer (S) zone formed by at least one S medium and wherein the S medium has a pH between the pH of an adjacent diluted T medium and the pH of an adjacent L medium.

134. The method according to claim 122, wherein the pH decreases from the T medium to the L medium if said method is for separating anionic analytes, or wherein the pH increases from the T medium to the L medium if said method is for separating cationic analytes.

135. The method according to claim 122, wherein said separation zone is configured to further comprise a spacer (S) zone formed by at least one S medium wherein the conductivity of a diluted T medium is about equal to the conductivity of an adjacent S medium;
or wherein the conductivity of an S medium is essentially identical with the conductivity of an adjacent L medium; or wherein the conductivity of a diluted T medium, an S medium and an L medium is about equal to each other.

136. The method according to claim 122, wherein said method is for separating at least one analyte of interest from a composition of analytes by ITP and wherein said analyte of interest is selected from the group consisting of cells, viruses, virus particles, organelles, liposomes, hormones, cellulose derivatives, antibodies, antibody complexes, protein aggregates, protein complexes, proteins, lipophilic proteins, acidic proteins, peptides, DNA-protein complexes, DNA, membranes, membrane fragments, lipids, saccharides and derivatives thereof, polysaccharides and derivatives thereof, charged polymers, charged complexes, polyacids, pharmaceutically drugs, prodrugs, a metabolite of a drug, explosives, toxins, carcinogens, poisons, allergens, infectious agents nanoparticles, and any combinations thereof.

137. The method according to claim 122, wherein said method is a free flow isotachophoresis (FF ITP) method.

138. The method according to claim 122, wherein said method is a free flow isotachophoresis (FF ITP) method and wherein the operation mode of said FF ITP separation is selected from the group consisting of continuous mode, static interval mode, and cyclic interval mode.

139. A kit for carrying out an ITP separation of at least analyte from a composition of analytes, comprising:
a T medium that contains a terminator T being a buffer compound, and
a strong base when the ITP is an anionic ITP, or a strong acid when the IPT is a cationic ITP.

140. The kit according to claim 139, further comprising a product manual that describes one or more experimental ITP protocols and, optionally, storage conditions for the components.

141. The kit according to claim 139, wherein the components of the kit are present as aqueous solutions ready for use in an ITP separation; or wherein the components of the kit are present as concentrated aqueous stock solutions that are to be diluted to the appropriate concentration for use in an ITP separation; or wherein the components of the kit are present in dried or lyophilized form that are to be dissolved with solvent to the appropriate concentration for use in an FF ITP separation

142. The kit according to claim 139, wherein each medium is independently provided in its ready to use form, as a stock solution or in dried form and each dried component and/or each stock solution of said kit is separately placed in a sealed container.

143. An apparatus comprising:
an electrophoresis chamber comprising a set of electrodes, wherein at least one of the electrodes is a cathode and at least one of the electrodes is an anode, and a separation zone interposed therebetween, wherein the separation zone is configured to include:
a terminator electrolyte (T) zone;
a diluted T zone;
a leader electrolyte (L) zone; and
an L stabilizing zone.

144. The apparatus of claim 143, wherein the apparatus is configured to separate at least one analyte of interest from a composition of analytes by free flow isotachophoresis (FF ITP).

145. The apparatus of claim 143,
wherein said separation zone is configured to further include a spacer S zone formed by at least one S medium, and
wherein the apparatus comprises at least 5 inlets through which said media are introduced into the chamber; and
wherein two adjacent “a” inlets have an inside bore diameter d of at most a factor of 0.8 compared to the inside bore diameter D of an “A” inlet,
wherein at least one “A” inlet is located between said two “a” inlets and each electrode.

146. The apparatus of claim 143, further comprising a separating device that contains separating arms which separate the inlets from each other, wherein the separating arms that separate two adjacent “a” inlets from each other and from the adjacent “A” inlets independently have a length that is at least a factor 1.5 longer than the separating arms separating the “A” inlets from each other.

147. The apparatus according to claim 143 for performing a separation of at least one analyte of interest from a composition of analytes by FF ITP,
wherein the apparatus comprises at least 5 inlets through which media are introduced into the chamber; and
wherein two adjacent “a” inlets have an inside bore diameter d of at most a factor of 0.8 compared to the inside bore diameter D of an “A” inlet,
wherein at least one “A” inlet is located between said two adjacent “a” inlets and each electrode; and further
wherein the distance
a) between said two adjacent “a” inlets is at most a factor of 0.8 of the distance between a pair of “A” inlets; and
b) between said two adjacent “a” inlets is at most a factor of 0.8 of the distance between a “a” inlet and an “A” inlet.
